(19) United States
(12) Patent Application Publication
(10) Pub. No.: US 2007/0205053 A1
(43) Pub. Date: Sep. 6, 2007

(54) Molded composite climbing structures utilizing selective localized reinforcement

(76) Inventors: William R. Isham, Alpine, UT (US); Stephen N. Webber, Cedar Hills, UT (US)

Correspondence Address: THORPE NORTH & WESTERN, LLP., 8180 SOUTH 700 EAST, SUITE 350, SANDY, UT, 84070, US

(21) Appl. No.: 11/707,642

(22) Filed: Feb. 16, 2007

Related U.S. Application Data
(63) Continuation-in-part of application No. 10/919,420, filed on Aug. 16, 2004.

(51) Int. Cl. E06C 5/04

(52) U.S. Cl. 182/207

(57) ABSTRACT

A method and system for fabricating molded composite support members for use in climbing structures, which molded composite support members comprise variable performance properties along a longitudinal length thereof. The variable performance properties are achieved or provided by selectively reinforcing one or more regions determined to be subject to greater stress, thus allowing a minimum amount of material to be used in other areas that will subject to less structural stress. Selective reinforcement is accomplished by adapting one or more regions of a primary composite material composition with a supplemental composite material composition, wherein the supplemental composite material composition increases the amount of composite material fibers within that particular region.

### RELATED APPLICATIONS

This continuation in-part application claims the benefit of U.S. application Ser. No. 10/919,420, filed Aug. 16, 2004, and entitled, “Lightweight Composite Ladder Rail Having Supplemental Reinforcement in Regions Subject to Greater Structural Stress,” which is incorporated by reference in its entirety herein.

### FIELD OF THE INVENTION

This invention relates to various types of climbing structures, as well as to the support members used in the manufacture and/or assembly of such climbing structures, and more particularly to molded composite support members for use in climbing structures.

### BACKGROUND OF THE INVENTION AND RELATED ART

Climbing structures, such as ladders, scaffolding, platforms, bleachers and others, in which a load (e.g., an individual or individuals, an object or objects, equipment, etc.) is intended to be supported are extremely common, and have found useful application in several different commercial settings and industries, in residential settings, and can be found virtually everywhere. The most common type of climbing structures are ladders and scaffolding, and types similar to these.

The use of portable ladders throughout history is well documented. Today, portable ladders are made not only of wood, but of aluminum alloys and composites using a variety of structural fibers.

Usually manufactured from spruce, wood ladders are relatively lightweight and inexpensive. As long as they are dry, they are safe for use around electricity. Wood ladders, though, have a number of drawbacks. Solid (i.e. non-laminated) pieces of wood used in the construction of ladders may have latent defects which can cause a structural failure. Wood is also subject to gradual, debilitating deterioration by moisture, sun, insects and microorganisms. Furthermore, expansion and contraction of wood caused by temperature and humidity changes can result in a gradual loosening of steps and braces, which requires frequent maintenance. Wood ladders also tend to be less stable in larger sizes.

Though aluminum alloys offer a high strength, lightweight alternative to wood, ladders made of aluminum alloys also have a number of drawbacks. Certain chemicals and salt water environments can corrode and weaken aluminum ladders. Although having excellent uniformity in the strength of structural members at the time of manufacture, the rails of aluminum ladders are easily bent and cracked. The most significant drawback is that aluminum is the third-best conducting metal. This attribute makes aluminum ladders extremely dangerous for work anywhere near high-voltage electrical wires. Historically, metal ladders have been the choice when electrical contact is not anticipated. Unfortunately, a ladder coming into contact with an electrical wire often occurs by accident. Therefore, a risk of electrocution may exist even when care is taken to avoid known and visible hazards. The problem is compounded because the light weight and high strength characteristics of metal ladders may be an inducement for their use even when electrical safety is a concern.

Though generally somewhat heavier and more expensive than aluminum ladders of the same size and rating, ladders having fiberglass composite rails joined with aluminum rungs have become extremely popular because they combine the best physical qualities of aluminum and wood ladders. The fiberglass composite rails will not conduct electricity. They are also very corrosion resistant. With minimal care and maintenance, fiberglass ladders can last generations.

Aluminum ladder rails are typically manufactured using an extrusion process. Fiberglass composite ladder rails, on the other hand, are typically manufactured using a pultrusion process. Pultrusion is a technique whereby longitudinally continuous fibrous materials are soaked in a resin bath and pulled through a heated die so that the resin sets and produces a rigid part downstream of the die. Both the extrusion process for aluminum rails and the pultrusion process for fiberglass composite rails produce rails of uniform cross section throughout their lengths. FIG. 1 shows a typical ladder rail 101 of uniform cross-sectional area throughout its length. The rail of FIG. 1 has a flattened C-shaped cross-section, and has been punched with a plurality of apertures 102. One end of a rung can be inserted in an aperture and anchored to the rail by mechanically swedging the rungs to the rails. The opposite end of the rung can be inserted in the aperture of a parallel rail and secured thereto in a like manner. Alternatively, each end of a rung can be welded or swedged to an attachment bracket that is either riveted or screwed to the ladder rail.

The greatest weakness of the composite pultrusion and aluminum extrusion manufacturing processes is that the cross-sectional profile of the rail must remain constant throughout its entire length. During use, a ladder rail is subjected to different levels of stress, torque, shear, flex and abuse in different regions along its length. Therefore, if the rail needs more strength in a particular region, material must be added to the entire length of the rail. Thus, a ladder rail of uniform cross section throughout its length is necessarily overly strong and heavy throughout much of its length, while those regions subjected to maximum stress, torque, shear, flex and abuse are designed to be just strong enough to support the maximum rated load—plus an additional safety factor load—without failure, under expected usage conditions. Consequently, all ladders having rails of uniform cross section throughout their lengths are considerably heavier than they need to be. Neither the extrusion process nor the pultrusion process is readily adaptable to the manufacture of rails of non-uniform cross section over their lengths. This non-optimum condition has heretofore been considered acceptable in the interest of minimizing manufacturing costs. Although there has always been an effort to design air and water craft so that no portion of a aircraft, ship or boat is any stronger than it needs to be, in order to minimize unloaded weight and thereby maximize payload and/or performance of the craft, the concept has been largely ignored by manufacturers of ladders.

Today, the need for ladders that are light in weight and that can be safely handled by an individual working alone is of greater significance than the need for ladders which have a low initial purchase price. The purchase price is likely only a tiny fraction of the total costs related to treating and compensating potentially career-ending physical injuries sustained while carrying, loading, unloading, setting up, and taking down a conventional ladder over its useful life. This is especially true when the number of persons working in trades that require the frequent use of a portable ladder, who are nearing retirement age, who have either a small stature or a history of previous injuries related to the lifting and carrying of heavy objects, is taken into consideration. Utility workers, electricians, construction workers and telecommunication installers, in addition to homeowners and those in many other industries, could benefit from the availability of ladders, especially extension ladders, which are significantly lighter than those of the same ratings and sizes currently available.

With respect to scaffolding, platforms, bleachers, etc., several support members are typically interconnected with one another to form a lattice or matrix of support members for the purpose of supporting a surface in an elevated position, which surface may be used to support individuals, objects, equipment, or any other load. Similar to the current technology for ladder rails, scaffolding support members are typically constructed of aluminum, using an extrusion process and comprise a uniform cross-section. As a result, providing localized reinforcement in needed areas or regions only in order to minimize material in other areas or regions, thus saving weight and costs, has also largely been ignored by manufacturers of these types of climbing structures.

### SUMMARY OF THE INVENTION

In light of the problems and deficiencies inherent in the prior art, the present invention seeks to overcome these by providing a method and system for fabricating molded composite support members for use in climbing structures, which molded composite support members comprise variable performance properties along a longitudinal length thereof. The variable performance properties are achieved or provided by selectively reinforcing one or more regions determined to be subject to greater stress, thus allowing a minimum amount of material to be used in other areas that will subject to less structural stress. Selective reinforcement is accomplished by adapting one or more regions of a primary composite material composition with a supplemental composite material composition, wherein the supplemental composite material composition increases the amount of composite material fibers within that particular region.

In accordance with the invention as embodied and broadly described herein, the present invention resides in a climbing structure configured to support a load, the climbing structure comprising a surface operable to receive a load thereon; and at least one composite support member configured to support the surface, and having variable performance properties along a longitudinal length thereof, the composite support member comprising a primary composite material composition having an elongate, channel-shaped configuration; and a supplemental composite material composition operable to adapt selective regions of the primary composite material composition to provide selective localized reinforcement for facilitating and enhancing the variable performance properties.

The present invention also resides in a composite support member operable within a climbing structure, the composite support member comprising a primary composite material composition having an elongate, channel-shaped configuration, and comprising material fibers oriented on a zero degree angle with respect to a longitudinal axis of the support member; and a supplemental composite material composition operable to selectively reinforce the primary composite material composition and to facilitate variable performance properties of the support member along a longitudinal length thereof, the supplemental composite material composition comprising a plurality of composite material fibers oriented to enhance the performance properties.

The present invention also resides in a composite support member for use within a climbing structure, the composite support member comprising a primary composite material composition having an elongate, channel-shaped configuration; and a supplemental composite material composition operable to adapt the primary composite material composition along substantially an entire length thereof, to provide reinforcement for facilitating and enhancing one or more performance properties of the primary composite material composition, the primary composite material composition and the supplemental composite material composition configured to provide a uniform cross-sectional area along a longitudinal length of the support member.

The present invention further resides in a method for fabricating a composite support member operable within a climbing structure, the method comprising preparing a primary composite material composition having an elongate, channel-shaped configuration; preparing a supplemental composite material composition; adapting a region of the primary composite material composition with the supplemental composite material composition to provide selective localized reinforcement of the primary composite material composition, and to form the composite support member, the supplemental composite material facilitating variable performance properties along a longitudinal length of the support member.

The present invention still further resides in a method for providing a climbing structure, the method comprising obtaining first and second composite support members, each having variable performance properties along a longitudinal length thereof provided by adapting a region of a primary composite material composition with a supplemental composite material composition to provide selective localized reinforcement of the primary composite material composition; and interconnecting the first and second composite support members to form at least a portion of the climbing structure.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of a prior art composite ladder rail of uniform cross-sectional area throughout its length;

FIG. 2 illustrates a perspective view of a composite ladder rail for the base section of a non-self-supporting extension ladder, the rail having non-uniform cross-sectional area throughout its length;

FIG. 3 illustrates an enlarged view of region 3 of the ladder rail of FIG. 2;

FIG. 4 illustrates an enlarged view of region 4 of the ladder rail of FIG. 2;

FIG. 5 illustrates an enlarged view of region 5 of the ladder rail of FIG. 2;

FIG. 6 illustrates a perspective view of a composite ladder rail for a self-supporting step ladder, the rail having a first reinforced region at a base end and a second reinforced region at hinged connection end;

FIG. 7 illustrates an enlarged view of region 7 of the ladder rail of FIG. 6;

FIG. 8 illustrates an enlarged view of region 8 of the ladder rail of FIG. 6;

FIG. 9 illustrates a cross sectional view of the ladder rail of FIG. 7, taken along line 9-9;

FIG. 10 illustrates a cross-sectional view of closeable mold for a composite ladder rail in an opened configuration, taken through a region of the mold designed for maximum rail thickness;

FIG. 11 illustrates a cross-sectional view of the closeable mold of FIG. 10 following the insertion of a structural fiber preform;

FIG. 12 illustrates a cross-sectional view of the closeable mold and inserted preform of FIG. 11 following the closing of the mold;

FIG. 13 illustrates a cross-sectional view of the closed closeable mold and inserted preform of FIG. 12 during the injection of resin into the mold cavity;

FIG. 14 illustrates a cross-sectional view of the mold of FIGS. 10-13, taken through a region of the mold designed for minimum rail thickness;

FIG. 15 illustrates a cross-sectional view of the mold of FIGS. 10-13, taken through a region of the mold designed for intermediate rail thickness;

FIG. 16 illustrates a top plan view of the cavity portion of the mold used to fabricate the rail portion of FIG. 9;

FIG. 17 illustrates a graphic representation of the cotton or cotton/polyester veil fabric used to encapsulate the structural fiber preform;

FIG. 18 illustrates a graphic representation of a second structural fiber layer, showing two sets of fibers, with fibers of the first set intersecting and interwoven with those of the second set, and with fibers of both sets oriented at a 45-degree-angle direction;

FIG. 19 illustrates a graphic representation of a first structural cloth fiber layer, showing a majority of structural fibers running in a 0-degree-angle direction from one end of the rail to the other and a minority of structural fibers running in a 90-degree-angle direction;

FIG. 20 illustrates a cross-sectional view of a vacuum-bagged open mold and a four-layer structural fiber preform;

FIG. 21 illustrates a partial perspective view of a composite ladder rail having a primary composite material composition consolidated with a supplemental composite material composition in select, localized regions along a length of the ladder rail;

FIG. 22-A illustrates a partial perspective view of a composite ladder rail having select regions along a length thereof adapted by a removable sleeve, wherein a supplemental composite material composition resides in the sleeve that functions to reinforce a primary composite material composition;

FIG. 22-B illustrates a cross-section of the composite ladder rail of FIG. 22-A, taken along line A-A;

FIG. 23-A illustrates a partial perspective view of a composite ladder rail having flanges reinforced by a supplemental composite material composition formed with a primary composite material composition, wherein the ladder rail comprises a uniform cross-section;

FIG. 23-B illustrates a cross-section of the composite ladder rail of FIG. 23-A, taken along line B-B;

FIG. 24-A illustrates an exploded cross-section of a composite preform (prior to being compressed and heated) comprising a primary and several supplemental composite material compositions;

FIG. 24-B illustrates a cross-section of a composite ladder rail formed from the preform of FIG. 24-A;

FIG. 25 illustrates a general block diagram of a bladder molding system used to form a molded composite support member in accordance with one exemplary embodiment of the present invention;

FIG. 26 illustrates a detailed cross-section of a composite material composition comprising material fibers oriented on a zero degree angle with respect to a longitudinal axis, and material fibers oriented transverse to the longitudinal axis, particularly on a ninety degree angle, and how these are secured to one another via a resin matrix;

FIG. 27 illustrates a cross-section of a molded composite support member having a channel-type configuration in accordance with one exemplary embodiment of the present invention;

FIG. 28 illustrates a cross-section of a molded composite support member having a channel-type configuration in accordance with another exemplary embodiment of the present invention;

FIG. 29 illustrates a cross-section of a molded composite support member having a channel-type configuration in accordance with another exemplary embodiment of the present invention; and

FIG. 30 illustrates a cross-section of a molded composite support member having a channel-type configuration in accordance with another exemplary embodiment of the present invention.

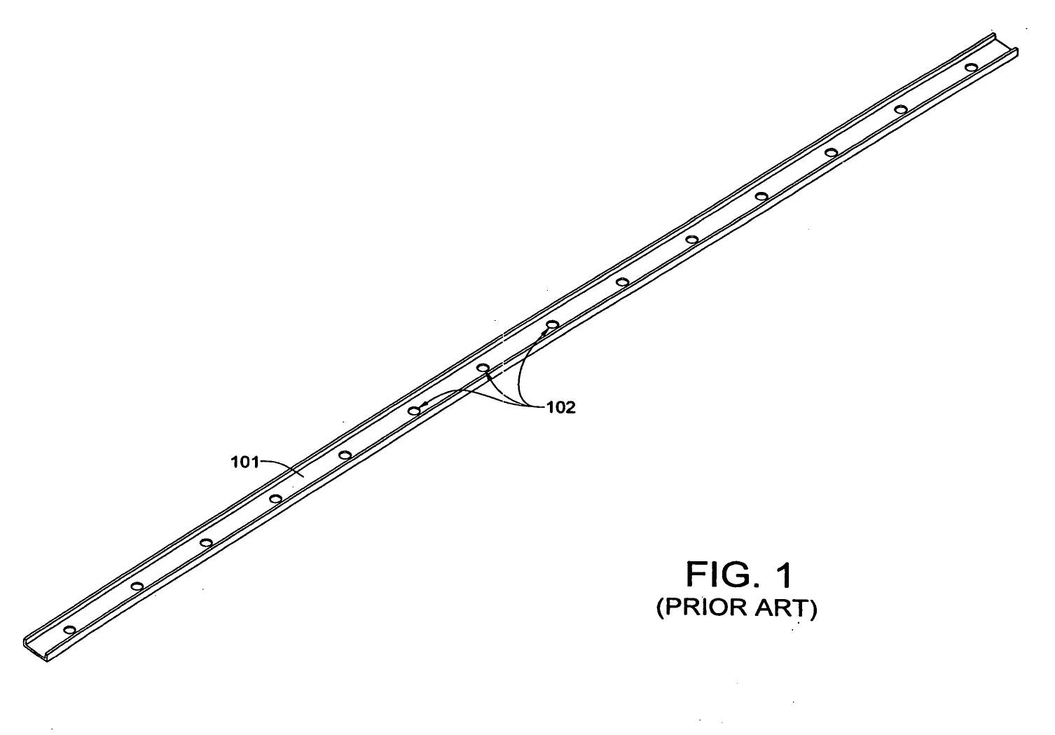

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims. The following detailed description and exemplary embodiments of the invention will be best understood by reference to the accompanying drawings, wherein the elements and features of the invention are designated by numerals throughout.

The present invention describes a method and system for fabricating molded composite support members for use in climbing structures, which molded composite support members comprise variable performance properties along a longitudinal length thereof. The variable performance properties are achieved or provided by selectively reinforcing one or more regions determined to be subject to greater stress, thus allowing a minimum amount of material to be used in other areas that will subject to less structural stress. Selective reinforcement is accomplished by adapting one or more regions of a primary composite material composition with a supplemental composite material composition, wherein the supplemental composite material composition increases the amount of composite material fibers within that particular region.

Advantageously, select regions may comprise supplemental composite material fibers without being constrained by the manufacturing process used to fabricate the support members. In other words, any region or area of a support member that may be subject to increased loading or stress may comprise supplemental reinforcement simply by increasing the number of material fibers in that region, wherein one or more composite manufacturing processes may be employed to either couple or consolidate such material fibers. In addition, select portions of a select region, or select portions of the support member, may be reinforced without having to reinforce unnecessary areas, thus allowing a greater optimization of strength to weight ratio, or allowing the performance properties to be enhanced and optimized while keeping weight and costs to a minimum. With the concepts discussed herein, composite support members for use in climbing structures may be fabricated having either uniform or non-uniform cross-sections.

The present invention provides several other significant advantages over prior related climbing structures and support members operable to provide a climbing structure, some of which are recited here and throughout the following more detailed description. First, the support members are comprised of a composite material capable of being molded, and therefore take advantage of the various techniques for fabricating composites. Second, reinforcement of the support members may be accomplished by reinforcing only select areas or regions of the support member, thus permitting the performance properties of the support member to be optimized, while also allowing weight to be kept at a minimum. Third, both uniform and non-uniform cross-sections are made possible, depending upon the type of method used to create the support member, and the application in which the support member is intended for use. Fourth, composite material fibers of different orientation may be used in reinforced areas or regions to secure other composite material fibers, thus eliminating the need to provide a separate fiber material or mat to secure the composite material fibers. Fifth, selective reinforcement in localized areas may be accomplished using a supplemental composite material composition, having composite material fibers therein, wherein the supplemental composition may be consolidated with a primary composite material composition (e.g., integrally formed with) at a desired location or area, or that may be formed and provided independently or separately (e.g., in the form of a clamp-on sleeve) and then removably coupled to a desired region or area. Sixth, different types of composite materials (e.g., thermoplastics, thermosets) may be used, along with different manufacturing methods (e.g., resin transfer molding, vacuum assisted resin transfer molding, compression molding, bladder molding, etc.), to create an optimal support member for use in a climbing structure.

Each of the above-recited advantages will be apparent in light of the detailed description set forth below, with reference to the accompanying drawings. These recited advantages are not meant to be limiting in any way. Indeed, one skilled in the art will appreciate that other advantages may be realized, other than those specifically recited herein, upon practicing the present invention.

The term “climbing structure,” as used herein, shall be understood to mean any type of structure utilized in one or more industries, wherein the climbing structure is configured to support a load from one or more individuals and/or one or more objects or items. As used herein, climbing structures are intended to comprise at least one composite support members, as defined and discussed herein. Examples of contemplated climbing structures include, but are not limited to, ladders, scaffolding, platforms, bleachers, planks utilized in scaffolding or platforms, and others known in the art.

The term “composite support member” or “support member,” as used herein, shall be understood to mean a molded composite structural support component utilized to assemble, fabricate and/or otherwise form part of a climbing structure. The composite support member may comprise primary composite material fibers, as well as one or more supplemental composite material fibers intended to reinforce the support member in selective regions or along selective locations. In addition, the composite support member may comprise a thermoplastic or thermoset type of composite. Exemplary types of composite support members may include, but are not limited to, ladder rails, individual interconnecting support members used in assembling scaffolding, platforms, bleachers, etc., and others known in the art.

The term “performance properties,” as used herein, shall be understood to mean those inherent properties of the climbing device, such as stiffness, strength, torsional resistance, dielectric or insulating capabilities, and others.

The term “channel-shaped structure” or “channel shape,” as used herein, shall be understood to mean a structure having opposing flange portions extending upward from a back or web to form a channel. The composite support member described herein comprises at least one channel, but may comprise others. Exemplary channel shapes include a U-shaped structure, a C-shaped structure, an I-shaped structure, a V-shaped structure (with no back or web), flanges that initially extend upward from the web or back on an incline or curve, and then transition into perpendicular flanges, and others as will be recognized by those skilled in the art.

The term “composite material composition,” as used herein, shall be understood to mean a composite component used in the fabrication of a composite support member. The composite material composition comprises fibers or composite fiber materials as known in the art. The composite material composition may comprise any number of fibers or layers of fiber materials. In addition, the composite material composition may comprise fibers oriented on a zero degree angle with respect to a longitudinal axis, fibers oriented transverse to the longitudinal axis, or both of these in various ratios.

To fabricate the molded composite support members of the present invention, structural composite fibers of many types may be used. Use of the following fibers is presently contemplated-glass (types E, S, S2, A or C), quartz, poly p-phenylene-2,6-bezobisoxazole (PBO), basalt, boron, aramid fibers such as Nomex® and Kevlar® (poly-para-phenylene terephthalamide), ultra-high-molecular-weight polyethylene, carbon, graphite and fiber hybrids such as carbon/aramid and carbon/glass. For climbing structures used near electrical circuits, support members having non-conductive fibers may be mandatory. Type E glass fibers have excellent dielectric properties and are the most commonly used structural fiber. However type S and S2 glass fibers have greater strength. Quartz fibers, while more expensive than glass, have lower density, higher strength and higher stiffness than E-glass, and about twice the elongation-to-break ratio, making them an excellent choice where durability is of paramount importance. Boron fibers, which are five times as strong, twice as stiff as steel, and non-conductive, are also ideal for structural fiber reinforcement of support members for use in climbing structures.

A discussion of resin matrices is also in order, as the present invention composite climbing structures, and particularly the support members utilized in these structures, may be implemented using a variety of different resin matrices. There are basically two kinds of polymeric resins, namely thermosetting and thermoplastic or thermoform resins. Certain types of resins are available in both formulations.

Unsaturated polyester resins are extensively used because of their ease of handling, good balance of mechanical, electrical and chemical properties, and relatively low cost. Typically used in combination with glass fiber reinforcements, polyester resins are most commonly used in compression molding and resin transfer molding. Several basic types of polyester resins are available, including orthopolyester resins, isopolyester resins and terephthalic polyester resins, with the latter type exhibiting increased toughness. Vinyl ester resins provide enhanced performance, as compared with polyester resins, but at additional cost. However, vinyl ester resins do not match the performance of high-performance epoxy resins. For advanced composite matrices, the most common thermosetting resins are epoxies, phenolics, cyanate esters, bismaleimides (BMIs), and polyimides. Most commercial epoxies have a chemical structure based on the diglycidy ether of bisphenol A or creosol and/or phenolic novolacs. Phenolics are based on a combination of an aromatic alcohol and an aldehyde, such as phenol combined with formaldehyde. Phenolics are relatively inexpensive and have excellent flame-resistance and heat absorption properties. Cyanate esters are high in strength and toughness, absorb little moisture, and are excellent dielectrics. Bismaleimides and polyimide resins are used in high-temperature applications. Polybutadiene resins are excellent dielectrics, resistant to chemicals, and may be used in many applications as an alternative to expoxy resins. Polyethermide thermoset resins, which are derived form bisoxazolines and formaldehyde-free phenolic novolacs, are a cost-effective alternative to eepoxy and bismaleimide resins.

A non-exhaustive list of commodity thermoplastic resins includes polyethylene (PE), polyethylene terephthalate (PET), polybutylene terephthalate (PBT), polycarbonate (PC), acrylonitrile butadiene acrylate (ABS), polyamide (PA or nylon), and polypropylene (PP). High-performance thermoplastic resins, such as polyetheretherketone (PEEK), polyetherketone (PEK), polyamide-imide (PAI), polyarylsufone (PAS), polyetherimide (PEI), polyethersulfone (PES), polyphenylene sulfide (PPS) and liquid crystal polymer (LCP), withstand high temperatures, do not degrade when exposed to moisture, and provide exceptional impact resistance and vibration dampening. These characteristics make them useful for the manufacture of composite climbing structures.

Cyclic thermoplastic polyester has excellent fiber wetting characteristics and offers the properties of a thermoplastic and the processing features of a thermoset.

Both polyimide and polyurethane resins are available in both thermoset and thermoplastic formulations.

Unlike many prior related climbing structures having support members manufactured using a pultrusion or similar process, the present invention employs a composite molding process to manufacture the one or more composite support members configured for use in a climbing structure, including those having one or more strategically structurally reinforced regions. Such molding processes include, but are not limited to high-pressure injection molding, resin-impregnated fiber molding, compression molding, resin transfer molding (RTM), using rigid closed mold or a combination hard and soft mold, vacuum-assisted resin transfer molding (VARTM) using a rigid or flexible cover over a one-sided mold, and various bladder molding processes in which a bladder and mandrel operate to form the support members within a mold cavity, many of which are well known in the art. Each of these is discussed in some detail below.

Using high-pressure injection molding, a structural preform is placed in a mold cavity, the mold closed, and a bulk molding compound, which may be a molten thermoplastic resin or uncured thermoset resin, is injected into the mold cavity under high pressure, completely wetting the preform and assuming the shape of the mold cavity. After the injected material cools (in the case of the thermoplastic resin) or cures (in the case of the thermoset resin) and solidifies, the completed part can be removed from the mold cavity.

Using resin-impregnated fiber molding, a controlled amount of thermoset or thermoplastic resin is incorporated into resin-impregnated structural fiber form (commonly called prepregs) using solvent, hot-melt or powder impregnation technologies. Prepregs can be stored in an uncured state until used. The prepreg structural preform is placed in a precision closed mold and subjected to heat and pressure. In the case of thermoplastic resin, the resin in the preform melts, wetting the structural fibers. The melted resin fibers or particles assume the shape of the mold. After cooling or curing, a finished part is removed from the mold. In the case of a thermoset prepreg part, the preform is stored in a refrigerator until it is cured in a heated precision closed mold.

Using compression molding, structural fiber layer is sandwiched between two layers of thick resin paste to form a sheet molding compound. A piece of the sheet molding compound is placed in a heated closed mold to which 500 to 1,200 psi of pressure is applied. Material viscosity drops and the sheet molding compound flows to fill the mold cavity. After cure, the mold is opened and the part removed. Though the compression molding process typically uses thermoset resins, it can also be used with thermoplastic resins.

Resin transfer molding (RTM), using a closed mold, is presently considered to be one of the preferred molding methods for quantity production of support members for climbing structures produced in accordance with the present invention. With RTM, both parts of a two-part, matched, closed mold are fabricated from metal or composite material. Alternatively, one part of a two-part compression mold is fabricated from metal or composite material, and a second part is fabricated from a compressible rubber material. After the dry fibers are placed in the mold, the mold is closed and the resin is then injected into the mold to wet the fibers and fill the mold. For thermoset resins, the mold can be heated to accelerate curing of the part, although that is not necessarily required if curing of the resin has been chemically initiated. For thermoplastic resins which are injected as a molten liquid, the injected material is simply allowed to cool to solidify after coating the fibers and filling the mold.

With vacuum assisted resin transfer molding, fiber reinforcements are placed in a one-sided mold and a cover, which may be either rigid or flexible, is placed over the top of the mold to form a vacuum-tight seal. When using a flexible cover, which is typically an air impermeable bag (e.g., a vacuum bag), the flexible cover essentially forms the other side of the mold. Catalyzed resin is typically introduced through strategically located ports on one side of the mold, and a partial vacuum is applied to ports located on the other side thereof. The partial vacuum extracts the air and pulls the resin through the preform to create the part. Once the resin sets up, the completed part is removed from the mold. Polyester, two-part epoxy, bismaleimide and polyetheramide resins are commonly used in the RTM and VARTM processes.

Within a bladder molding process, a mandrel/bladder assembly is provided that is operable to conform a composite preform to one or more walls of a mold cavity of a mold. The mandrel/bladder assembly may comprise a mandrel sized and configured to fit within the mold cavity, and to define, at least in part, a volume of space between the mandrel and the preform, each as positioned within the mold cavity. The mandrel/bladder assembly further comprises an actuatable bladder supported about at least a portion of and operable with the mandrel, and which is configured to fill the volume of space upon being actuated to cause the preform to conform to the mold cavity. The mandrel/bladder assembly is operable with a bladder molding system comprising various support components, heaters, etc. to fabricate a finished composite article, such as a composite climbing structure as described herein. Exemplary bladder molding processes particularly useful in fabricating the climbing structures described herein are set forth in copending U.S. Provisional Application No. ______, filed Feb. 16, 2007, and entitled, “Bladder Molding Systems and Methods for Fabricating Composite Articles” (Attorney Docket No. 2384-003), which is incorporated by reference in its entirety herein.

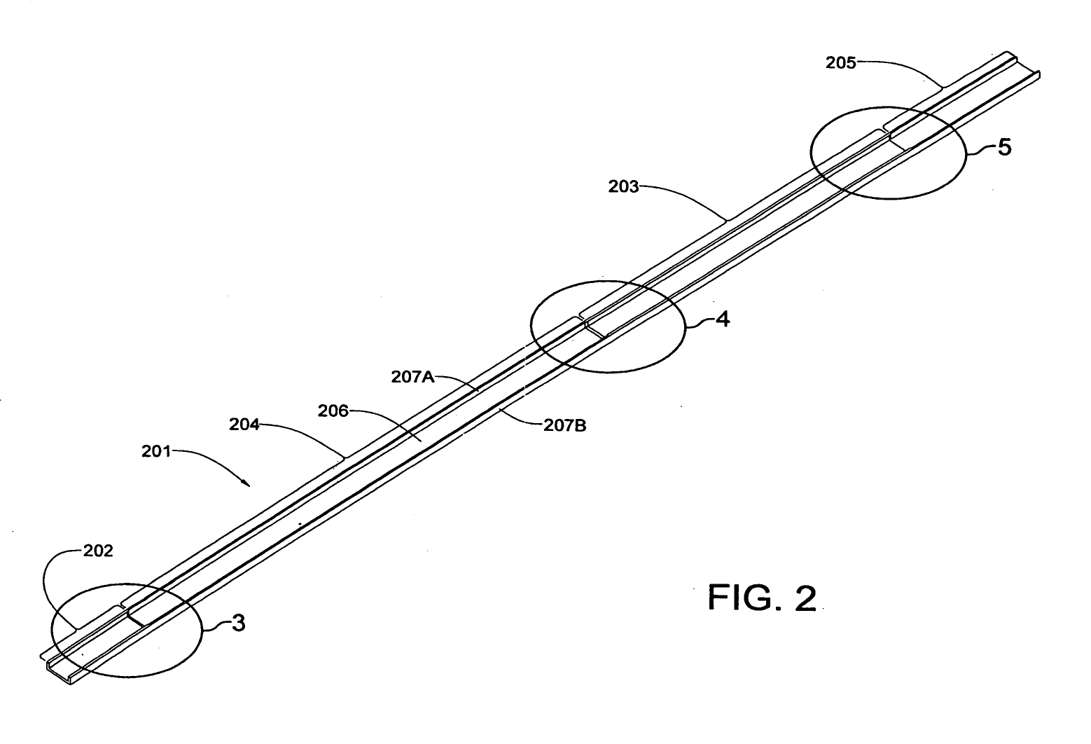

As indicated above, the present invention contemplates several different types of climbing structures that may be fabricated in accordance with the teachings as described and set forth herein. With the reference to FIGS. 2-20, specific exemplary composite support members in the form of ladder rails for use in ladder-type climbing structures, and the processes which may be used to manufacture such ladder rails, will now be described in detail. The exemplary ladder rails shown in FIGS. 2-20 comprise a non-uniform cross-sectional area, as taken along a longitudinal axis of the ladder rail.

It is understood that support members, other than ladder rails, may comprise a similar configuration and makeup. As such, each of the different types are not specifically described herein. However, one skilled in the art will be able to recognize that the teachings of a support member in the form of a ladder rail for use in a ladder-type climbing structure, wherein the ladder rail incorporates variable performance properties through reinforcement along its longitudinal length, as described herein, may be applicable to the fabrication of support members of different types for use in different climbing structures, such as scaffolding. As such, the specific discussion of ladder rails presented herein is not meant to be limiting in any way.

It is also to be understood that the drawing FIGS. are merely illustrative of exemplary ladder rails and processes used to manufacture or fabricate these. In essence, it is contemplated that a composite ladder rail may be supplementally reinforced in strategic locations in one or more longitudinal regions, for a variety of applications, by increasing the number of structural fibers in those regions, resulting in a corresponding increase in the thickness of the rail and its cross-sectional area in the structurally-reinforced regions. The technique of supplemental reinforcement in strategic locations about the composite support member, or ladder rail, can be applied to ladder rails of different types intended for use in ladders of different types and intended for a variety of applications. Such ladders may include, but are not limited to, self-supporting step ladders, non-self-supporting extension ladders, and combination ladders.

Referring now to FIG. 2, a first embodiment composite ladder rail 201 is shown that may be used in the fabrication of a base section of a non-self-supporting extension ladder such as the one that is the subject of U.S. Pat. No. 5,758,745 (the '745 patent) granted to Robert D. Beggs, et al. This patent is hereby incorporated by reference into the present application. The rail 201 has a flattened C-shaped cross-section, which is of non-uniform area throughout its length. The rail 201 comprises a rail back 206 and rail flanges 207A and 207B extending upward from the rail back 206. The rail 201 has an augmented cross-sectional area at the lower end 202, to which a hingeable foot will be attached in a conventional manner, and at a maximum and near-maximum extension overlap region 203. As the foot of the ladder is subject to impact abuse, it would benefit from being reinforced with additional structural fibers for added strength. The overlap region 203 would also benefit from being reinforced in a like manner because of additional stresses applied to the rail and rail flanges 207A and 207B when the fly section (not shown) of the extension ladder is at or near maximum extension. As such, the rail flanges 207A and 207B and the rail back 206 are reinforced in select locations to provide additional strength, stiffness and other properties to the ladder rail. In other words, the cross-sectional area of the ladder rail is increased in select locations to reinforce the ladder rail.

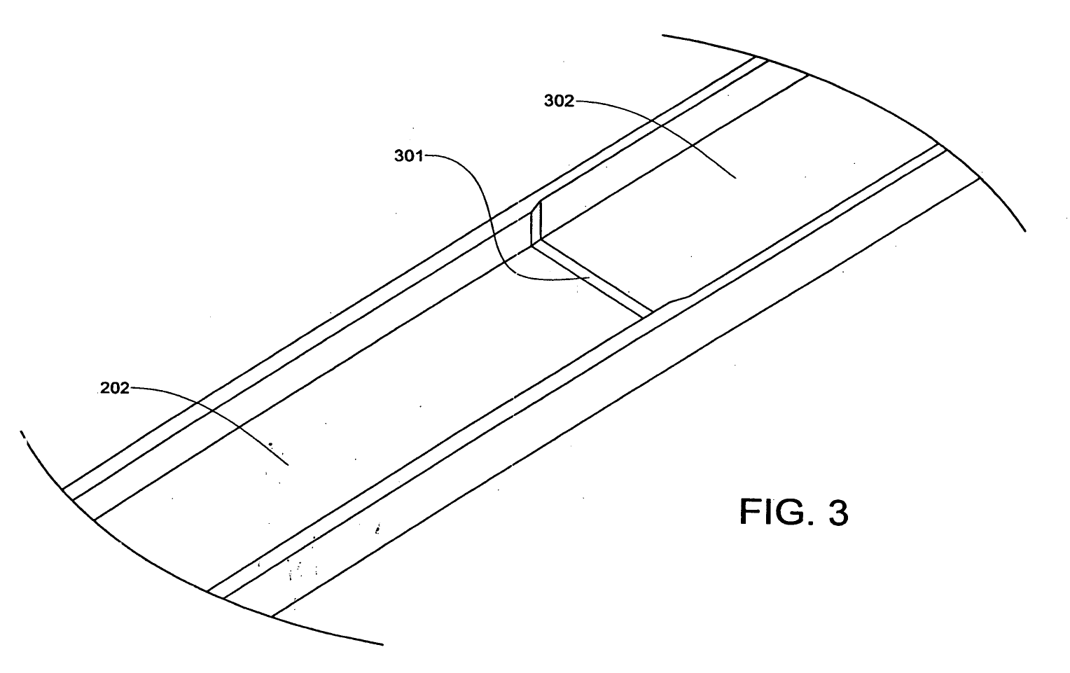

Referring now to FIG. 3, the detail of the structurally reinforced lower end 202 of rail 201 is visible. It will be noted that there is a ramped transition region 301, rather than an abrupt transition between the lower end 202 and a central region of lesser cross-sectional area 302. The ramped transition 301 serves to reduce stresses where the lower end 202 meets the central region 302, and to more appropriately distribute loads between the lower end 202 and the central region 302.

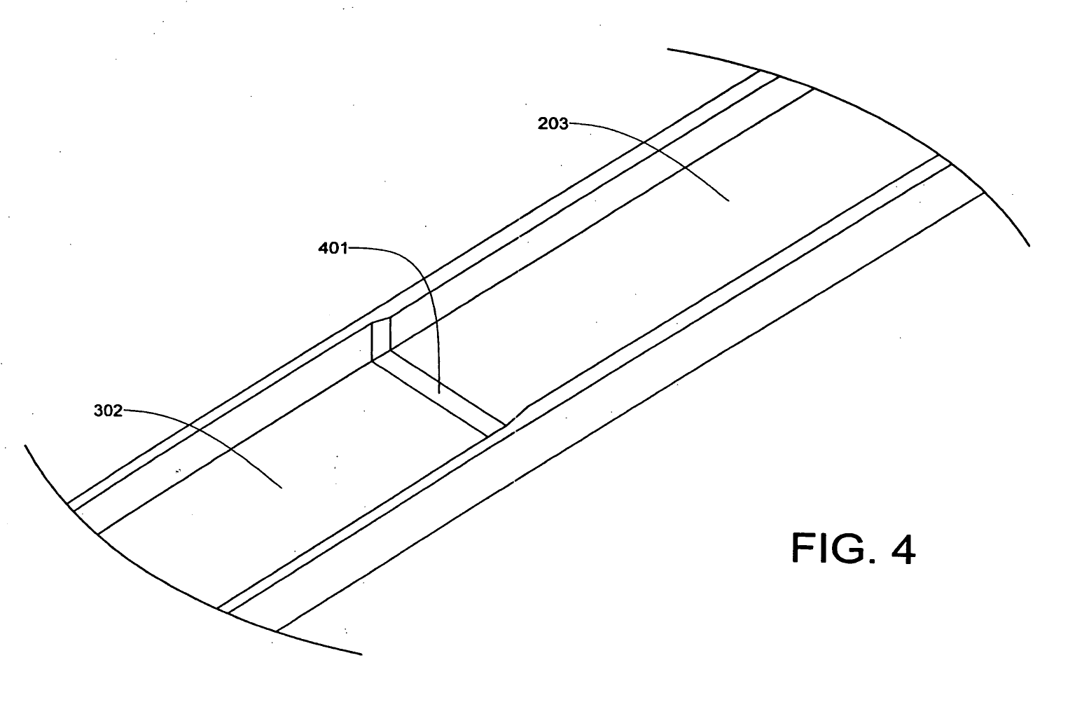

Referring now to FIG. 4, a ramped transition region 401 between the central region of lesser cross-sectional area 302 and the extension overlap region 203 is visible in greater detail. The ramped transition 401 serves to reduce stresses where the central region 302 meets the extension overlap region 203.

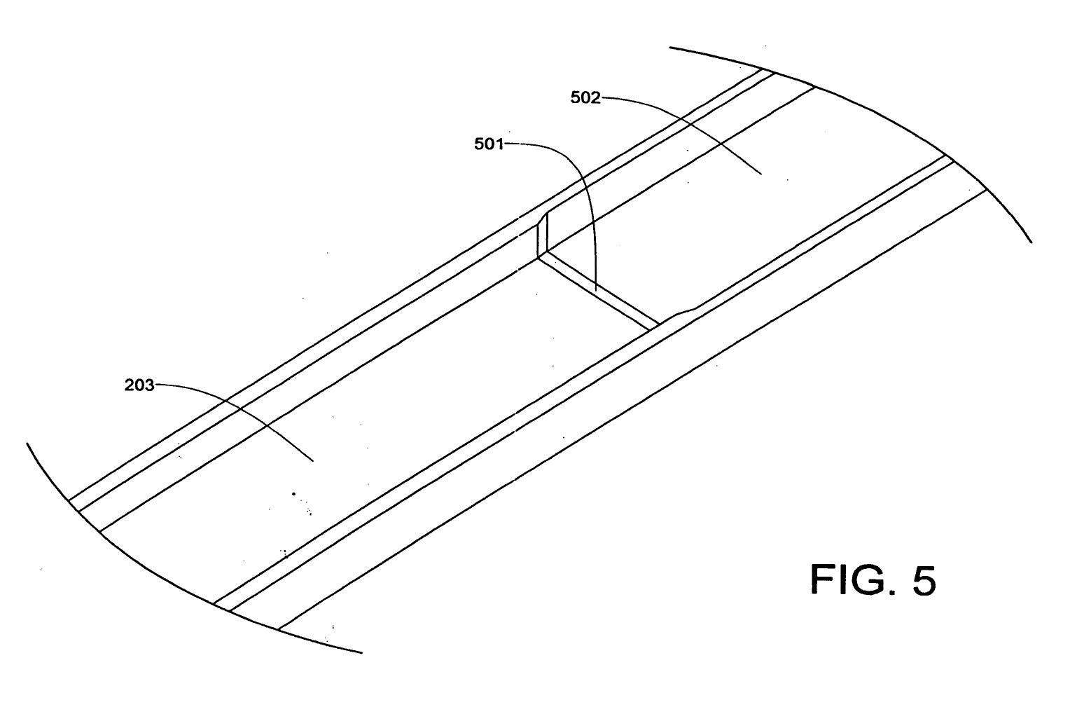

Referring now to FIG. 5, a ramped transition region 501 between the extension overlap region 203 and an upper end of lesser cross-sectional area 502 is visible in greater detail. The ramped transition 501 serves to reduce stresses where the extension overlap region 203 meets the upper end 502.

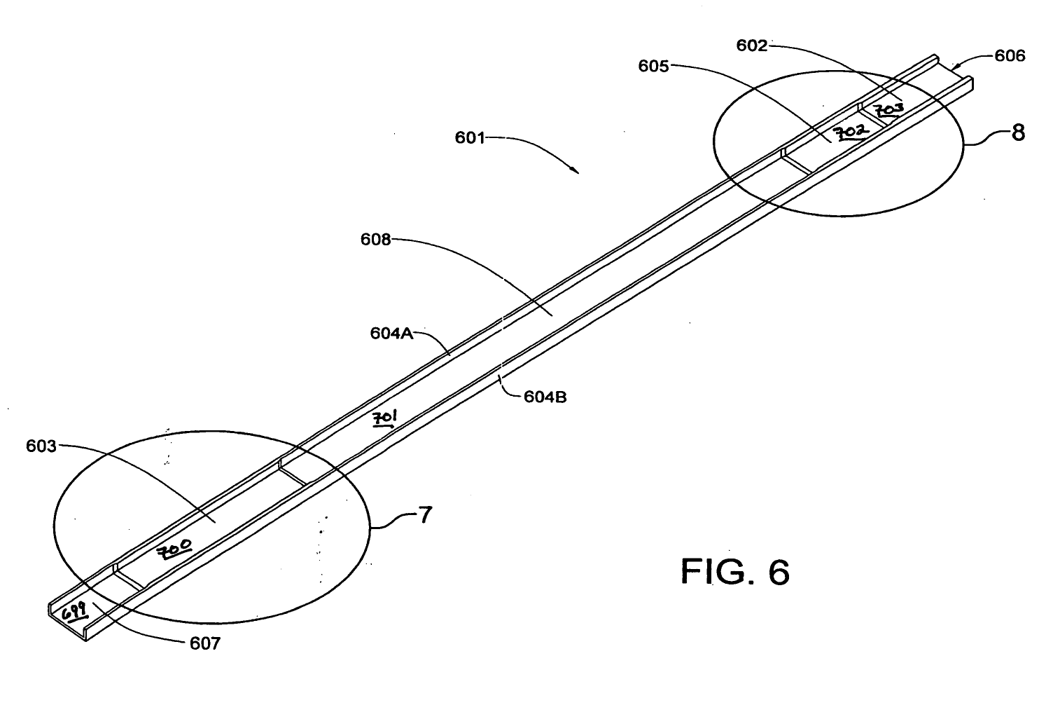

Referring now to FIG. 6, a second embodiment composite ladder rail 601 is shown that may be used in the fabrication of a self-supporting combination step and extension ladder such as the one that is the subject of U.S. Pat. No. 4,371,055 (the '055 patent) granted to Larry J. Ashton, et al. This patent is hereby incorporated by reference into the present application. The ladder of the '055 patent includes a pair of base sections, each of which is fabricated from a plurality of rungs interconnecting a pair of channeled outer side rails of molded fiberglass, and a pair of fly sections, each of which is fabricated from a plurality of rungs interconnecting a pair of inner side rails of molded of fiberglass. Each of the inner side rails is telescopically mounted within an outer side rail so that the inner side rails can be extended to increase the height of the ladder in either configuration. The two fly sections are hinged together at the top ends so that the ladder may be folded and unfolded from a step ladder configuration to a straight extension ladder configuration and vice versa.

By incorporating four second embodiment rails 601 into the fly sections of the combination ladder of the '055 patent, the weight thereof can be substantially reduced. Still referring to FIG. 6, each second embodiment rail 601 is reinforced at the top end 602 where the hinges, which interconnect the fly sections, attach. The rail 601 is also reinforced in a lower overlap region 700, along segment 603, between region 699 and segment 607 and region 701 and segment 608 because of additional stresses applied to the rail base, and particularly the rail flanges 604A and 604B, when the base and fly sections of the combination ladder are at or near maximum extension. Reinforcement of the top end 602 occurs in two steps, with region 702, along segment 605, being a transition region from region 701 and segment 608 to the region 703 and the top end 602. Both the rail flanges 604A and 604B, as well as the rail back 606, are similarly reinforced. Regions 699 and 701 are of standard thickness and reinforcement.

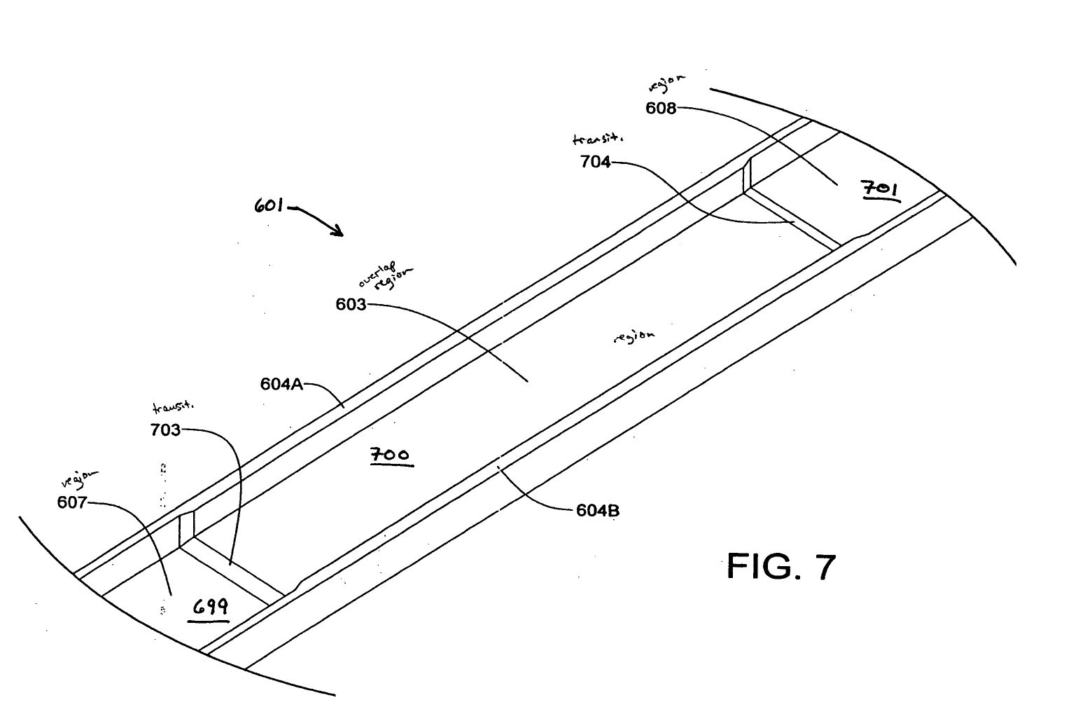

Referring now to FIG. 7, the details of the extension overlap region 603 are clearly shown. The ramped transitions 703 and 704 serve to reduce stresses where the extension overlap region 700 and segment 603 meets the lower region 699 and segment 607 and central region 701 and segment 608, both of which are of standard thickness. Again, as shown, the flanges 604A and 604B and rail back 606 are reinforced in select locations to provide additional strength, stiffness and other properties to the ladder rail. In other words, the cross-sectional area of the ladder rail is increased in select locations to reinforce the ladder rail.

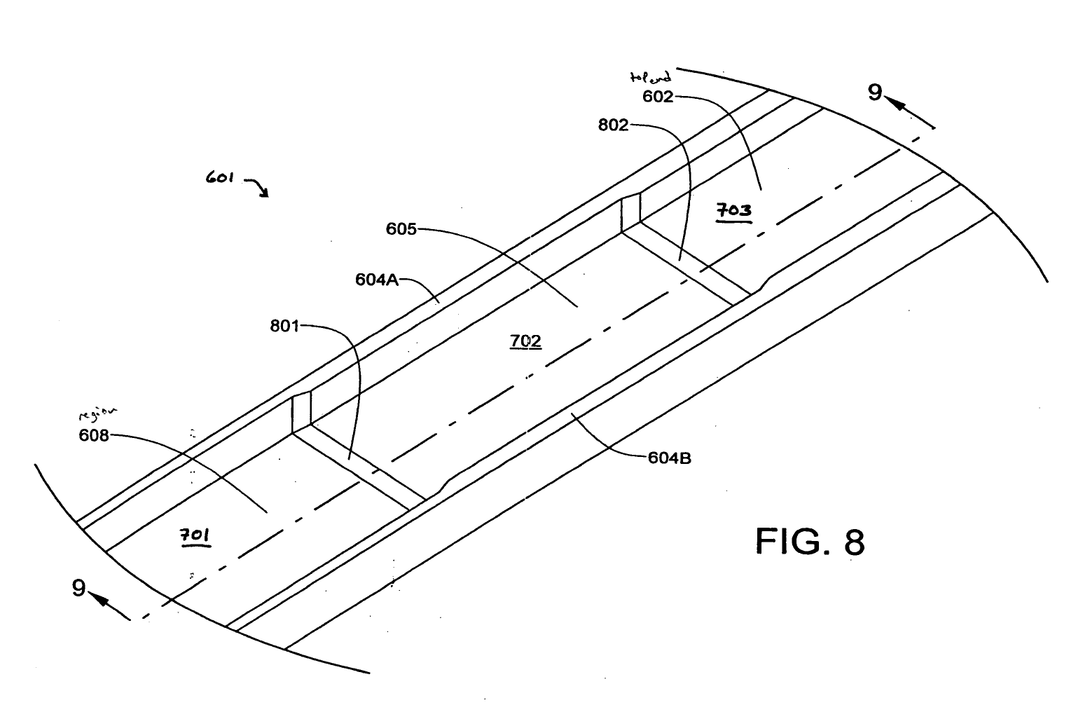

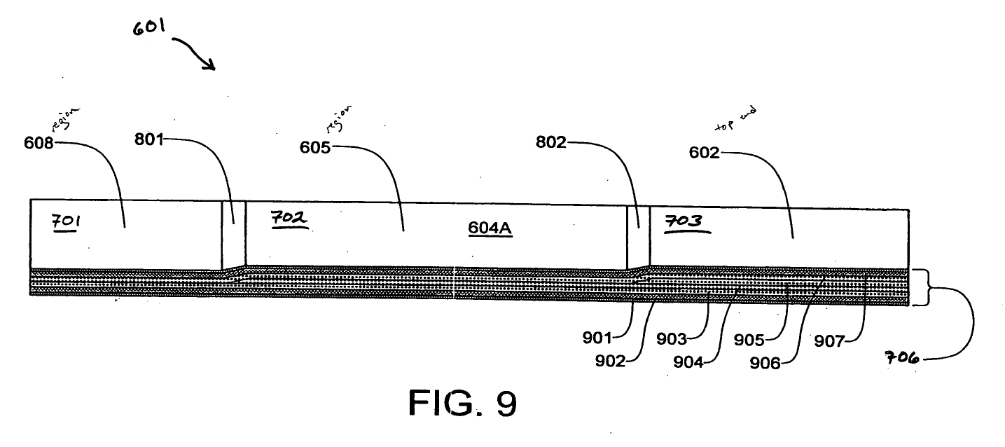

Referring now to FIG. 8, the top end 602 of rail 601 is reinforced in two steps or locations, which correspond to the addition of discrete layers of structural fibers. In this view, it is shown that each rail flange 604A and 604B transitions from a minimum standard thickness in a central region 701 to an intermediate thickness in region 702 to a maximum thickness in region 703. Likewise, the rail back 606 transitions in thickness in two steps or locations across these regions, which is explained in FIG. 9. Essentially, transition 801 provides a reinforcement transition from the central region 701 and segment 608 to region 702 and segment 605. Transition 802 provides a reinforcement transition from region 702 and segment 605 to region 703 near top end 602.

Referring now to FIG. 9, taken along lines 9-9 of FIG. 8, this longitudinal cross sectional view shows that the rail back 706, like the rail flanges (only rail flange 604A being shown), transitions from a minimum standard thickness in the central region 701 and segment 608 to an intermediate thickness in region 702 and segment 605 to a maximum thickness in region 703 and top end 602, via transition 801 and 802, respectively. For a presently preferred embodiment of the invention, the maximum thickness region 703 employs six layers of structural fibers, shown as fiber layers 902, 903, 904, 905, 906 and 907, respectively. Layers 903, 904, 905 and 906 have a majority of structural fibers running in a zero (0°) degree angle, or longitudinal (i.e., lengthwise) direction within the rail. A minority of the fibers within layers 903, 904, 905 and 906 may be configured or disposed to run generally at a ninety degree (90°) angle, or perpendicularly, with respect to the fibers running longitudinally at a zero degree angle. Other fiber orientations may be provided. For example, the structural fibers in layers 902 and 907 may be configured to run in both a forty-five degree (45°) and/or two hundred twenty-five degree (225°) angle direction and a one hundred thirty-five degree (135°) and/or three hundred fifteen degree (315°) angle direction, each with respect to the longitudinal axis of the ladder rail 601.

The ladder rail 601 may further comprise a veil layer 901 of finely woven cotton/polyester cloth to encapsulate the structural fiber layers and minimize the problem of fiberglass segments projecting through the surface of the rail. The transitions 801 and 802 within the rail back 606 wrap upwardly from the rail back 706 to the rail flanges 604A and 604B.

It should be understood that the multi-layered preform of FIG. 9 is meant to be merely exemplary. Although woven fabrics are bi-directional and provide good strength in the direction of the yarn orientation, the tensile strength of woven fabrics is compromised to some degree because fibers are crimped as they pass over and under one another during the weaving process. These fibers tend to straighten under tensile loading, causing stress within the matrix system. Thus, one preferred preform for ladder rail manufacture is assembled using a continuous-strand mat. A single mat having all desired fiber orientations may be employed for the regions of minimum cross-sectional area or multiple layers having different orientations may be used, as in the example of FIG. 9. In any case, additional layers are intended to be strategically added to the preform where it must be strategically strengthened. An alternative to the continuous-strand mat is a multi-axial (non-woven) fabric made with uni-directional fibers laid atop one another in different orientations and held together by through-the-thickness stitching or knitting. This process avoids the fiber crimp associated with woven fabrics because the fibers lie on top of one another, rather than crossing over and under. For multi-axial fabrics, the proportion of yarn in any direction can be selected at will.

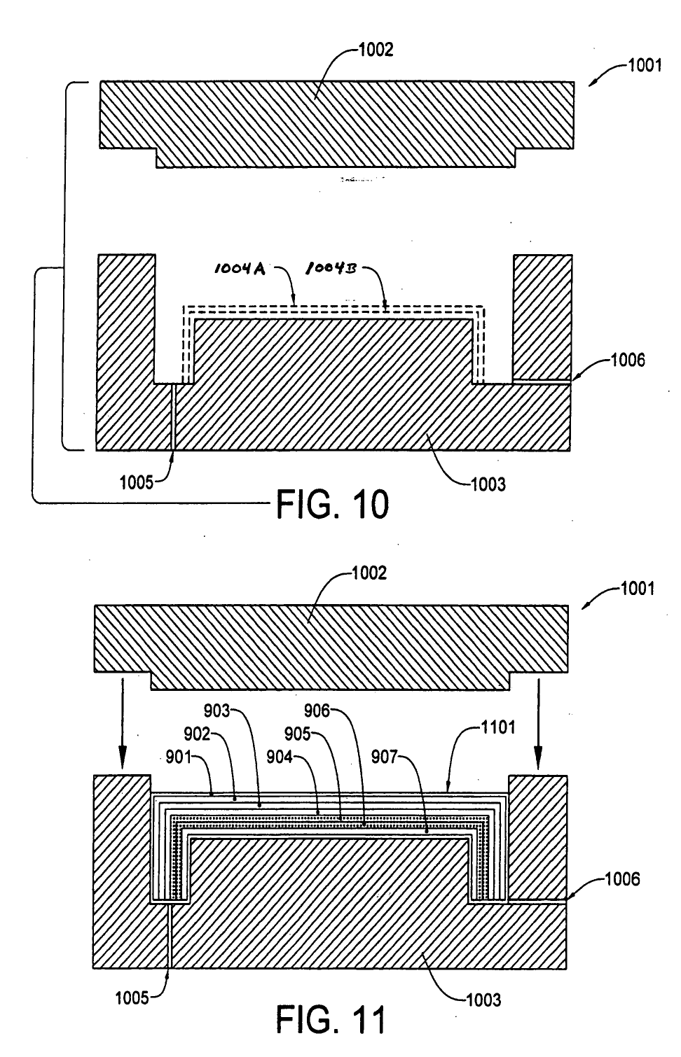

Referring now to FIG. 10, the cross-section of a closeable mold 1001 for fabricating a composite ladder rail having a non-uniform cross-sectional area (taken along a longitudinal axis) in accordance with the present invention is shown. The closeable mold 1001 is a two-part mold, having lid portion 1002 and a cavity portion 1003. The cross-section of the mold shown in FIG. 10 is sized for maximum thickness. The dashed lines 1004A and 1004B show the respective shapes that the mold cavity would have for molding various reinforcement sections or regions, such as the minimum thickness regions and intermediate thickness regions of the rail shown in FIGS. 6-9 and discussed above. The cavity portion 1003 of mold 1001 is equipped with a resin inlet aperture 1005 and an air escape vent aperture 1006.

Referring now to FIG. 11, a structural fiber preform 1101, which in this region of the rail, consists of layers 902, 903, 904, 905, 906 and 907 and the encapsulating veil layer 901, is inserted within the mold cavity. The mold lid portion 1002 will be used to close the mold cavity portion 1003.

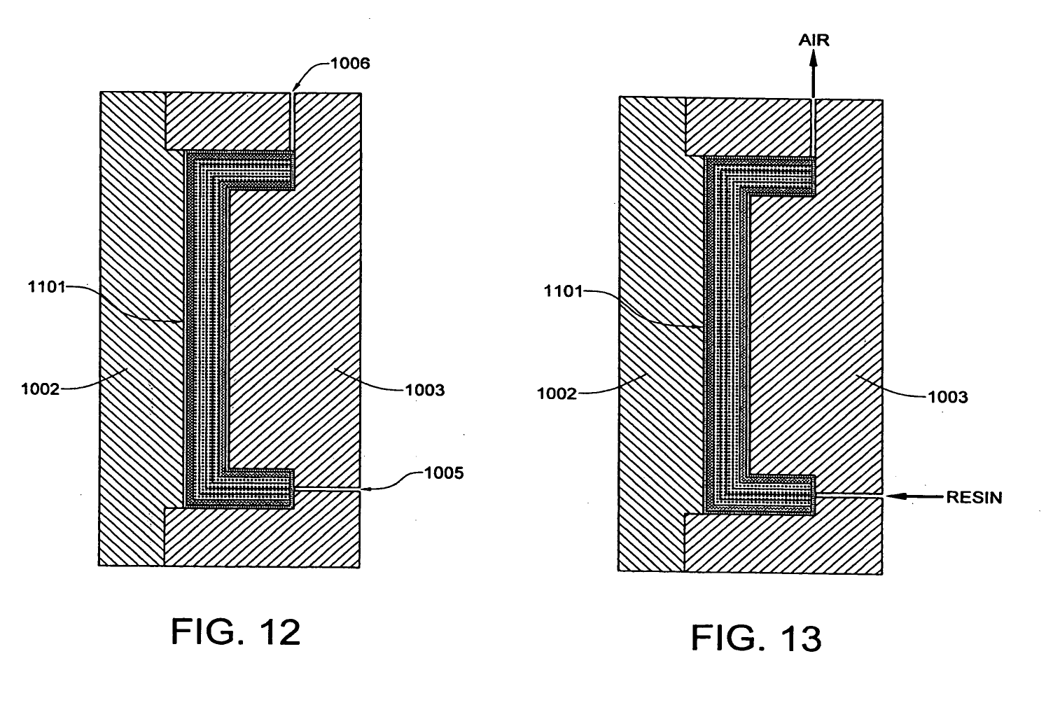

Referring now to FIG. 12, the mold 1001 has been closed and rotated so that the air escape vent aperture 1006 is at the top of the mold, thus allowing for the removal of air and other volatiles.

Referring now to FIG. 13, resin is shown as being injected into the mold, saturating the structural fiber preform 1101. Once the resin attains green status, a solid but not-fully-cured state, the mold may be opened and the rail 601 removed from the mold cavity portion 1003.

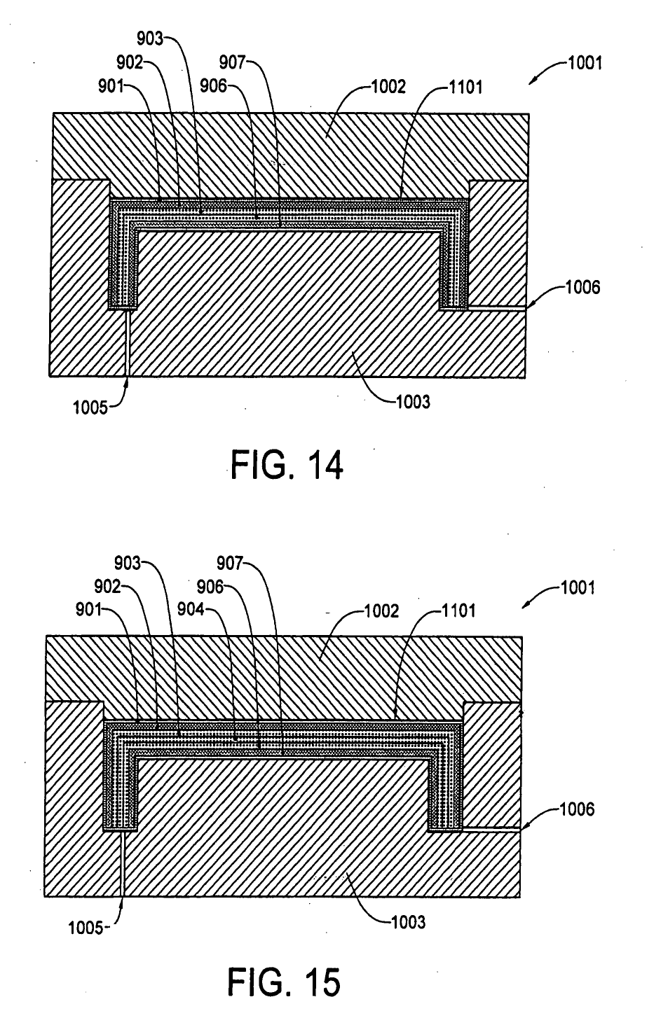

Referring now to FIG. 14, a region of the mold 1001 for molding the minimum thickness regions of the composite ladder rail 1301 is shown. In this portion of the mold, the preform 1101 consists of the veil layer 901, two layers of intersecting diagonal structural fibers 902 and 907, and two 0°/90° angle layers 903 and 906.

Referring now to FIG. 15, a region of the mold 1001 for molding the intermediate thickness regions of the composite ladder rail 1301 is shown. In this portion of the mold, the preform 1101 consists of the layers found in the preform section of FIG. 14 plus an additional 0°/90° angle layer 904.

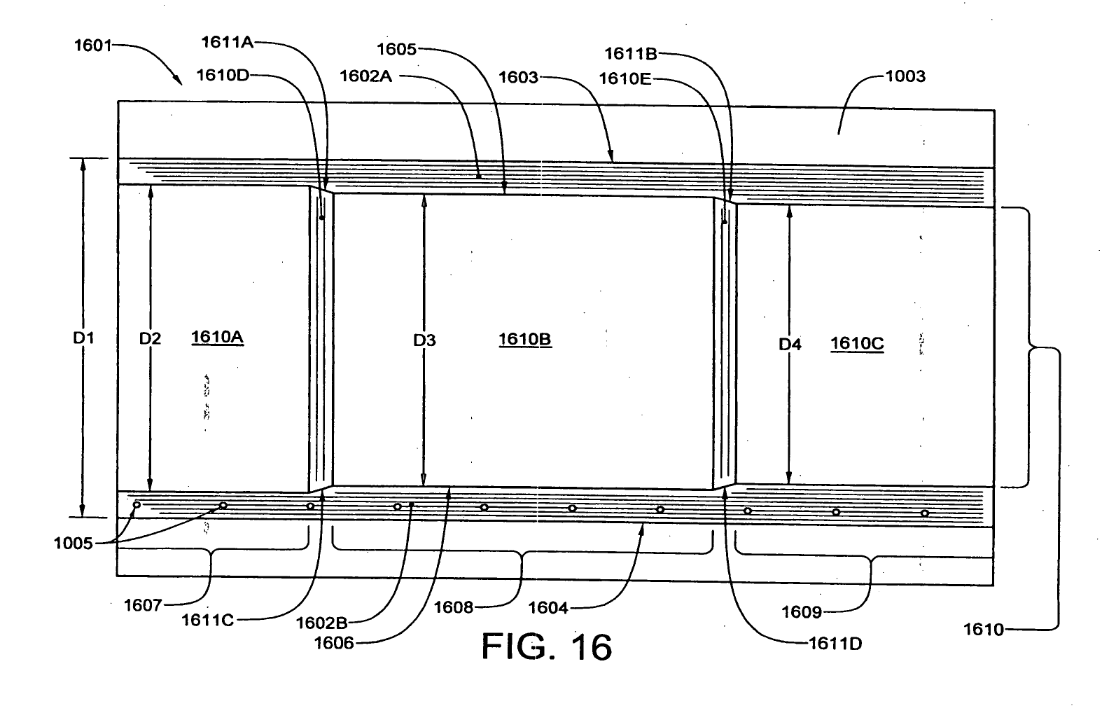

Referring now to FIG. 16, shown is a section 1601 of the cavity portion 1003 of the mold 1001 used to fabricate the section of rail 601 shown in FIG. 9. It should be well understood that this is only a small portion of the entire mold 1001. A plurality of resin inlet apertures 1005, which are generally evenly spaced within the mold 1001, are clearly visible. The mold 1001 employs a plurality of generally evenly-spaced air escape vent apertures, which are not shown in this view. The presently preferred embodiments of the composite rails fabricated in accordance with the present invention are of flattened U-shaped or C-shaped cross section, as can be seen in FIGS. 2-9. Although the rails have been designed so that the outer surface of the U-shape is constant and that only the interior shape changes, the invention may be practiced using the opposite technique of maintaining a constant shape on the inside or channel of the rail and reinforcing the outer surfaces, thus varying the shape of the outer surface of the rails. In other words, although the mold 1001 of FIG. 16 employs the technique of providing a constant outer surface and varying the inner surface, the opposite technique of having a constant inner surface and varying outer surface will also work.

The flange recesses 1602A and 1602B are completely visible, with the distance D1 between the outer wall 1603 of flange recess 1602A and the outer wall 1604, of flange recess 1602B remaining constant over the entire length of the mold. The distance between the inner wall 1605 of flange recess 1602A and the inner wall 1606 of flange recess 1602B, on the other hand, varies from a maximum D2 in region 1607, where the flanges are thinnest to a minimum D4 in region 1609, where the flanges are thickest. In region 1608, the distance D3 is an intermediate value. The rail back surface mold surface 1610 of the mold cavity portion 1003 of mold 1001, which sculpts the inner surface of the rail back, is divided into three regions of different levels. Region 1610A is nearest the viewer, region 1610C is farthest from the viewer, and region 1610B is positioned at an intermediate distance from the viewer. It will be noted that there are also ramps 1610D and 1610E between the different levels of the rail base 1610 mold surface. It will also be noted that the transition regions 1611A, 1611B, 1611C and 1611D between regions of different levels for the rail flange recesses 1602A and 1602B are ramped, rather than abrupt, in order to reduce stresses at the transition region.

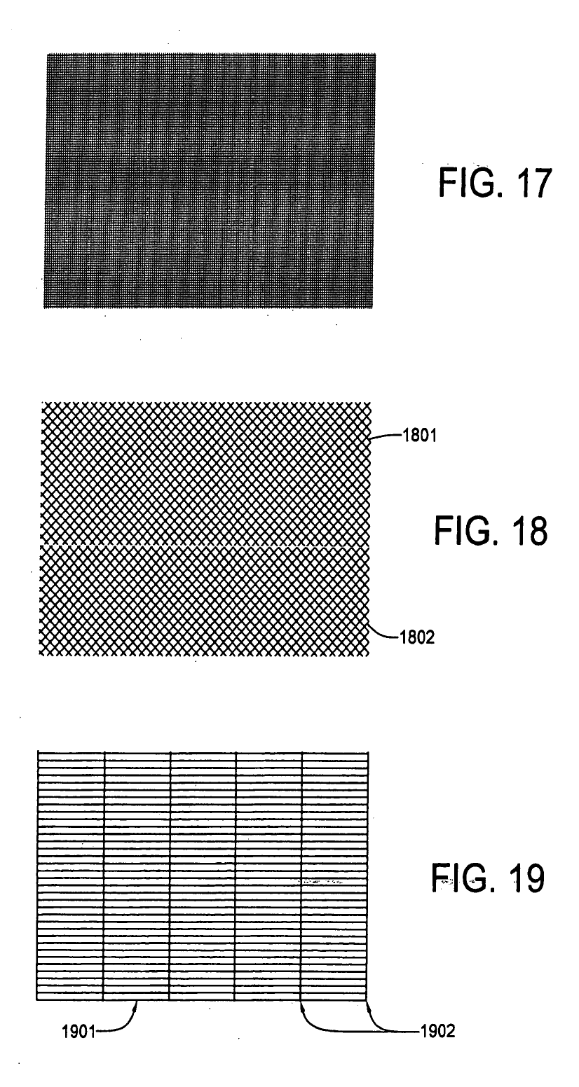

Referring now to FIG. 17, a swatch of the cotton or cotton/polyester veil fabric 1701 used for the veil layer 906, which encapsulates the structural fiber preform 1101, is shown. One way of encapsulating the structural fiber preform 1101 is to line the bottom and sides of the mold cavity with a sheet of veil fabric 1601, fold the edges of the veil fabric sheet to the sides, insert the preform, and fold the sides of the veil fabric sheet so that the edges overlap, and then close the mold.

Referring now to FIG. 18, a swatch of layer 902 is shown. Layer 902 has a first set of fibers 1801 which are oriented along a 45°/225° angle direction, and a second set of fibers 1802 which are oriented along a 135°/315° angle direction.

Referring now to FIG. 19, a swatch of layer 901 is shown. Layer 901 comprises a set of fibers 1901 which are oriented along a 0° angle direction, and a second set of fibers 1902 that are oriented along a 90° angle direction. Both the majority of 0° angle fibers 1901 and the minority of 90° angle fibers 1902 are shown.

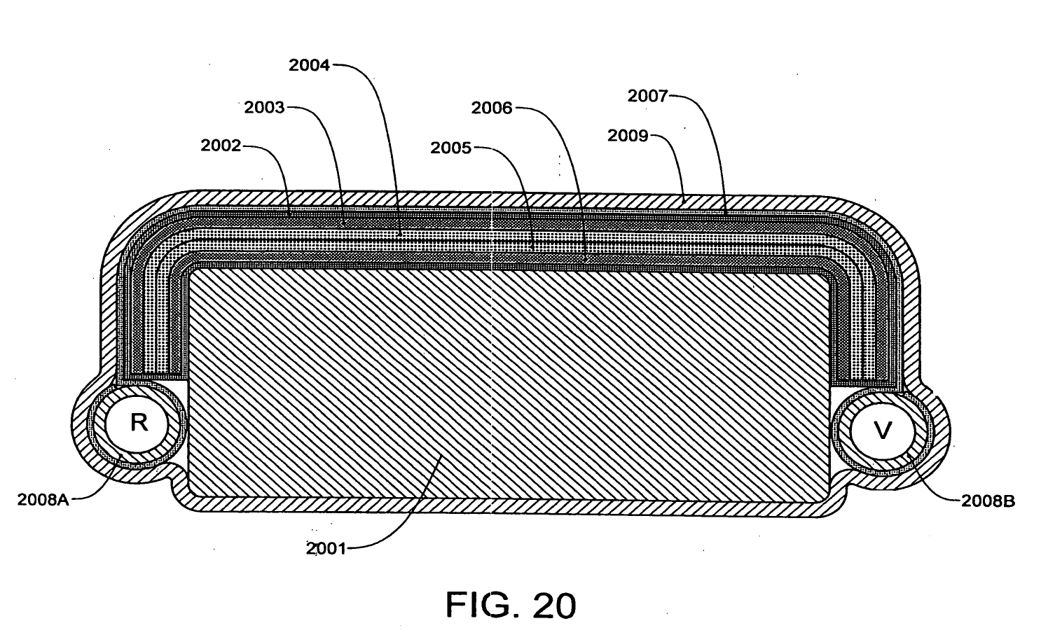

Referring now to FIG. 20, a rail may be fabricated in accordance with the present invention using an open mold and vacuum bagging to remove air from the preform. A mold block 2001 has been covered with a veil layer 2002 and four structural fiber layers 2003, 2004, 2005 and 2006. The veil layer 2002 has been wrapped around the structural fiber layers so that all structural fibers layers are wrapped within it. A porous mold release sheet 2007 is placed over the veil-wrapped structural fiber layers and each of the longitudinal edges of the mold release sheet 2007 is wrapped around a coil-spring tube 2008A and 2008B. Coil-spring tube 2008A has a central aperture labeled R, through which a thermosetting resin is injected after being mixed with a chemical initiator. The mold block 2001, the veil-wrapped structural fiber layers, the release sheet 2007 and the coil-spring tubes 2008A and 2008B are enclosed in an air impermeable bag 2009. A partial vacuum is applied to the aperture (which is labeled V) of coil-spring tube 2008B. The resin flows between the individual coils of the coil-spring tube 2008A, through the porous mold release sheet 2007, and through the veil wrapped structural fiber lay-up to the coil-spring tube 2008 to which the partial vacuum has been applied. The air-impermeable bag 2009 molds the outer surface of the ladder rail, which will be comprised of the veil, the structural fiber layers, and the resin, once it has cured.

It should be apparent that a composite ladder rail may be fabricated in accordance with the present invention for use with a folding step ladder. U.S. Pat. No. 4,718,518 to William E. Brown (the '518 patent) discloses one convertible step ladder having a two-piece back section. This patent is hereby also incorporated by reference into the present application. A lower piece of the back section is removable so that the step ladder can be used on stairs as well as on a flat surface. Composite or fiberglass rails may be molded in accordance with the present invention for use with either a conventional step ladder having a one-piece back section or for a convertible step ladder. The rails may be reinforced in appropriate locations, such as the foot of the rail, the top of the rail where it is hinged, or an attachment region for a removable lower piece of the back section.

It should be understood that different types of steps may be incorporated into any of the types of ladders discussed herein. Various methods for attaching steps to the rails may also be used. For example, the step may be swedged or welded to a bracket which is attached with rivets or screws to the rail. Alternatively, a hole may be cut or stamped in the rail, and an end of the step inserted within the hold and held in place with swedged retaining rings. The types of steps to be used and the method of their attachment to the rail fall largely outside the scope of this disclosure, as many types of steps and many methods of step-to-rail attachments are well known in the art and may be applied to the art of ladder manufacture using the rails of the present invention. That is to say that the practice of the present invention is not limited to any particular type of step or any particular method of step-to-rail attachment.

It should also be evident that the preforms used to make the rails of the present invention may be completely formed prior to their insertion in the mold, or they may be constructed by laying up multiple layers, which may even be done manually within the mold.

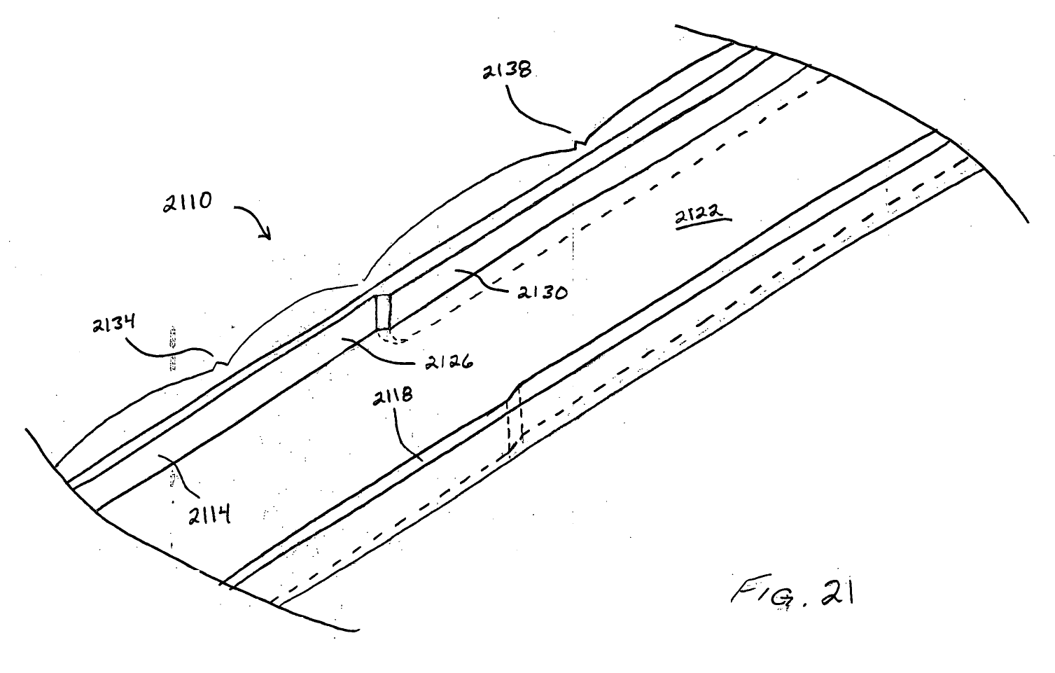

With reference to FIG. 21, illustrated is a partial perspective view of a molded composite support member, in the form of a ladder rail, formed in accordance with another embodiment of the present invention. As shown, the composite ladder rail 2110 comprises a first flange 2114 and a second flange 2118 opposite one another and extending upward from a web or flange back 2122. The composite ladder rail 2110 is configured to comprise variable performance properties along a longitudinal length thereof provided by adapting a region 2138 of a primary composite material composition, shown as composition 2126 along the first flange 2114, with a supplemental composite material composition, shown as composition 2130, also along the first flange 2114, to provide selective localized reinforcement of the primary composite material composition 2126. The second flange 2118 may be adapted in a similar manner to comprise a supplemental composite material composition.

In this particular embodiment, the primary and supplemental composite material compositions 2126 and 2130, respectively, are intended to be shown as being consolidated or integrally formed with one another to form a unitary flange, or a unitary support member. This is accomplished in an initial fabrication process, or in a subsequent process, such as a remold process.

It is noted that unlike the composite ladder rails shown in FIGS. 2-20, the flanges 2114 and 2118 are adapted to comprise supplemental reinforcement with all or a majority of the web or flange back 2122 not comprising supplemental composite material for reinforcement, as such may not be needed. Indeed, the supplemental composite material composition 2130 may be configured to extend only along the flanges 2114 and 2118, or it may be configured to extend along the flanges and partially along the web or flange back 2122 (see dotted lines about flange 2114 in FIG. 21) to provide support to and through the intersection or junction of the first and second flanges 2114 and 2118 and the flange back 2122. With the flanges being the primary components comprising supplemental reinforcement, this helps to reduce the overall weight of the support member 2110 without sacrificing strength, stiffness, torsional resistance and other performance properties. In this particular configuration, the web or flange back 2122 may comprise composite fiber materials oriented transverse to the longitudinal axis of the support member 2110 in addition to fiber materials oriented on a zero degree angle with respect to the longitudinal axis of the support member 2110 to increase the performance properties of the web or flange back 2122.

Although FIG. 21 illustrates a single reinforced region, this is not meant to be limiting in any way. Indeed, the ladder rail 2110 may comprise a plurality of localized reinforcement regions or areas, or portions thereof, along its longitudinal length, which reinforcement regions may or may not overlap or connect to one another. The same is true for the other exemplary embodiments discussed herein.

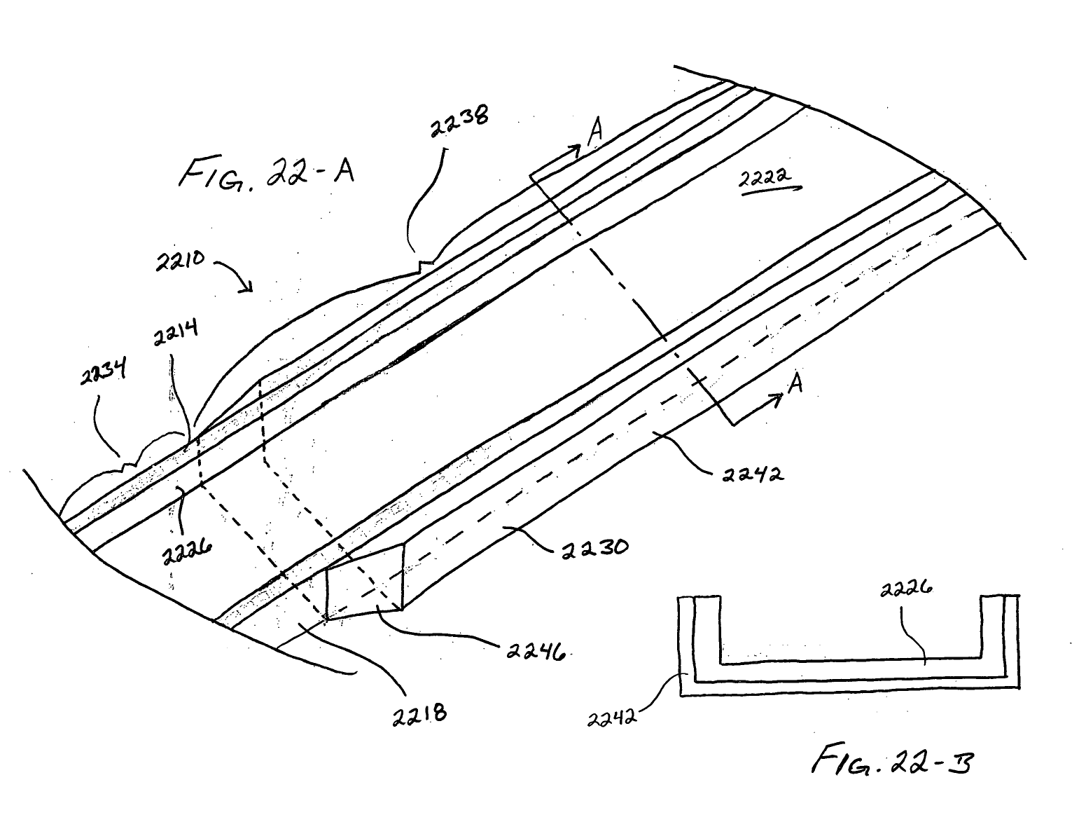

With reference to FIGS. 22-A and 22-B, illustrated is a partial perspective and a cross-section view, respectively, of a molded composite support member, in the form of a ladder rail, formed in accordance with another exemplary embodiment of the present invention. As shown, the ladder rail 2210 comprises a first flange 2214 and a second flange 2218 opposite one another and extending upward from a web or flange back 2222. The composite ladder rail 2210 is configured to comprise variable performance properties along a longitudinal length thereof provided by adapting a region 2238 of a primary composite material composition, shown as composition 2226 with a supplemental composite material composition, shown as composition 2230, to provide selective localized reinforcement of the primary composite material composition 2226.

In this particular embodiment, the primary and supplemental composite material compositions 2226 and 2230, respectively, are independent of one another, or in other words they are not integrally formed or consolidated with one another. Rather, the supplemental composite material composition 2230 comprises composite material fibers that are configured as and that reside within a sleeve 2242, which sleeve 2242 is formed independent of the primary composite material composition 2226. The sleeve 2242 is configured to be removably coupled to the primary composite material composition 2226 using any known means in the art, such as bolting, clamp-on, and others. In the exemplary embodiment shown, the sleeve 2242 is shown as comprising a clamp-on coupling means utilizing an interference fit. In addition, the sleeve 2242 is shown as providing reinforcement to both the first and second flanges 2214 and 2218, respectively, as well as the web or flange back 2222.

The sleeve 2242 is shown as further comprising a tapering portion 2246 configured to provide a smooth transition from the sleeve 2242 to the primary composite material composition 2226. The tapering portion 2246 further functions to more evenly distribute loads about the primary composite material composition 2226, and to reduce the concentration and localization of forces within a given area so as to eliminate local weak spots.

With reference to FIGS. 23-A and 23-B, illustrated is a partial perspective view and a cross-section, respectively, of a molded composite support member, in the form of a ladder rail, formed in accordance with another exemplary embodiment of the present invention. As shown, the ladder rail 2310 comprises a first flange 2314 and a second flange 2318 opposite one another and extending upward from a web or flange back 2322. Unlike the composite ladder rails discussed above that are configured to comprise variable performance properties along a longitudinal length thereof, ladder rail 2310 is configured to comprise more consistent or constant performance properties along its longitudinal length. Reinforcement of the ladder rail 2310 is provided by adapting, along an entire length of a primary composite material composition, shown as composition 2326, with a supplemental composite material composition, shown as composition 2330-a and 2330-b, to provide continual reinforcement of the primary composite material composition 2326 in a longitudinal direction.

As can be seen, the ladder rail 2310 comprises a uniform cross-section having a superior strength to weight ratio and superior performance properties over prior related ladder rails having a uniform cross-section. This is primarily the case as the web or flange back 2322 is not required to comprise added material, thus allowing its thickness t_{w} to be less than the thickness t_{f} of the first and second flanges 2314 and 2318. In one aspect, the supplemental composite material compositions 2330-a and 2330-b may be configured to extend about a surface of the flanges 2314 and 2318, respectively, terminating at or prior to the intersection or junction of the flanges and the web or flange back 2322. However, in another preferred aspect, the supplemental composite material compositions 2330-a and 2330-b are configured to be positioned and extend about a surface of the flanges 2314 and 2318, respectively, and at least partially about a surface of the web or flange back 2322, through the intersection or junction of the flanges and the web or flange back to reinforce this intersection or junction. By extending through the intersection, a radius r of increased strength is provided, thus improving the overall strength and stiffness of the ladder rail 2310.

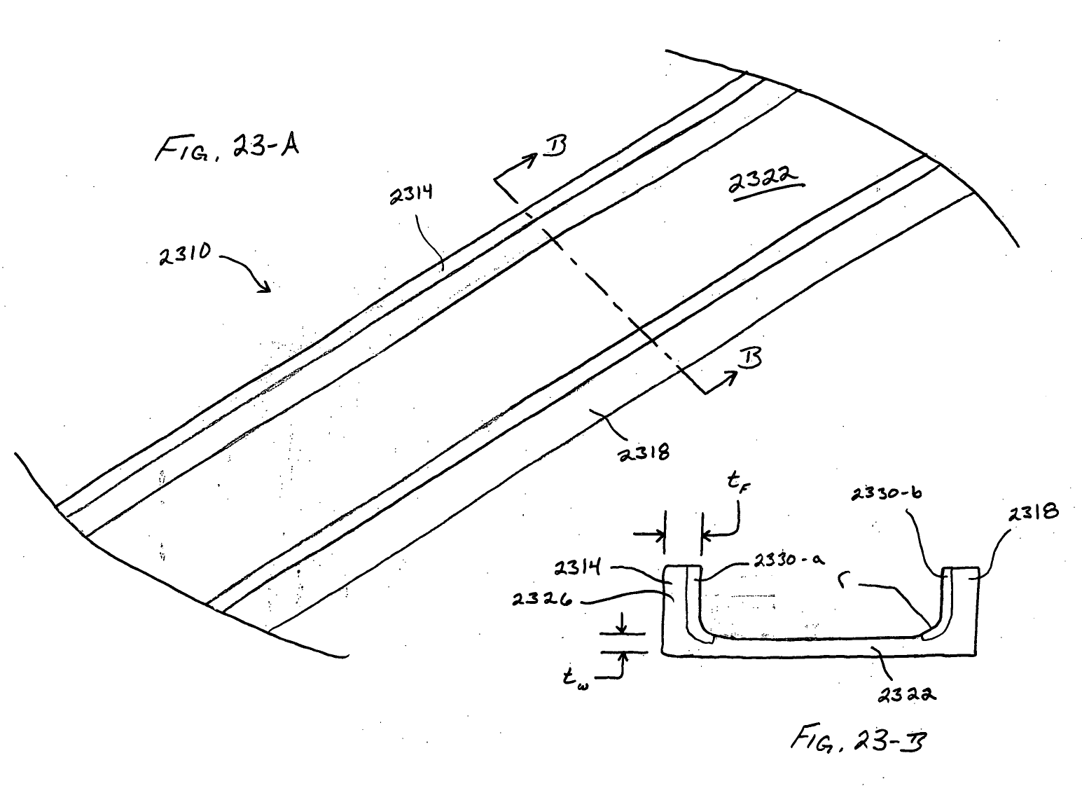

With reference to FIG. 24-A, illustrated is an exploded cross-section of the components used to fabricate a support member, in the form of a ladder rail, in accordance with another exemplary embodiment of the present invention. As shown, the ladder rail 2410 comprises a primary composite material composition 2426 operable to be molded into a desired configuration, such as one having a channel-shaped configuration with opposing flanges extending from a web to define a channel. Operable with the primary composite material composition 2426 to fabricate the ladder rail 2410 is one or more supplemental composite material compositions, shown as compositions 2430-a, 2430-b, 2430-c, and optional 2430-d (represented in phantom view).

FIG. 24-A is intended to illustrate that one or more supplemental composite material compositions may be employed to selectively reinforce the primary composite material composition 2426. Specifically, it is contemplated that one or more supplemental composite material compositions, some of which may be sized and shaped differently, may be positioned within various regions along the length of and about the primary composite material composition 2426. Furthermore, it is contemplated that each of the primary and supplemental composite material compositions used to fabricate and reinforce the support member 2410 may comprise a bundle of material fibers oriented on a zero degree angle with respect to a longitudinal axis of the support member, a bundle of material fibers oriented transverse to the longitudinal axis, or a combination of these. The support member of the present invention is intended to comprise a total fiber content, some of which fibers may be oriented in different directions.

For example, within a combination of material fibers oriented in different directions, the ratio of material fibers oriented on a zero degree angle with respect to those transversely oriented may vary. Specifically, the percentage of material fibers oriented on a zero degree angle may range between 70 and 95 percent of the total fiber content of the support member, with the percentage of material fibers oriented transverse to the longitudinal axis ranging between 5 and 30 percent of the total fiber content of the support member. Orientations of fiber content in these ranges has been found to provide optimal results in fabricated support members, namely to keep weight and manufacturing costs to a minimum without sacrificing desired performance properties. The function of the different fiber orientations is discussed below.

With reference to FIG. 24-B, illustrated is a cross-section of a ladder rail formed from the components of FIG. 24-A. As shown, the ladder rail 2410 comprises a primary composite material composition that may include material fibers oriented in the same or in different directions (e.g., both zero degree angled fibers and transverse fibers). The ladder rail 2410 further comprises supplemental composite material compositions 2430-a that reinforces flange 2414 and a portion of web 2422, supplemental composite material composition 2430-b that reinforces flange 2418 and a portion of web 2422, and supplemental composite material composition 2430-c.

One or both of the primary composite material composition 2426 and the supplemental composite material composition 2430-c are intended to comprise a percentage of transversely oriented material fibers for the purpose of securing the opposing sides or flanges 2414 and 2418 of the ladder rail 2410 together. By securing opposing sides of the ladder rail together with material fibers oriented transverse to the longitudinal axis of the ladder rail, improved performance properties are realized. Again, a discussion on material fiber orientation and the relationship of these to the performance properties of the support member is provided below.

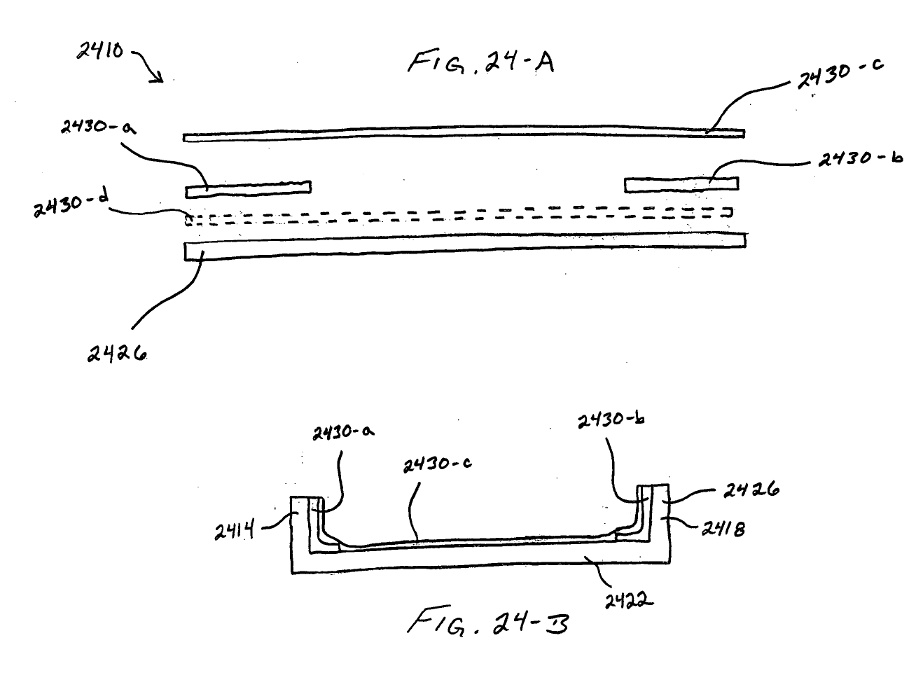

With reference to FIG. 25, illustrated is a general block diagram of a bladder molding system used to form a composite support member for use within a climbing structure in accordance with one exemplary embodiment of the present invention. The bladder molding system 2550 comprises a fundamental framework concept, to which additional components may be added to reduce labor or increase cycle times as desired. In some exemplary embodiments, the fundamental framework or structure may comprise a plurality of steel beams (not shown, but preferably parallel to one another). Depending upon the type of composite articles to be fabricated, the framework may comprise different sizes. For example, in the event of fabrication of ladder rails, the steel beams may be between 12 and 20 feet long.

A relatively flat platen 2562 may be situated above the beams, which platen functions as a support on which a mold 2554 having a mold cavity 2558 may rest. In other words, the platen 2562 provides a working surface. The platen 2562 and the mold 2554 may be any size and configuration as needed.

The beams may be affixed atop a plurality of support legs (not shown), which would function to bring the working surface to a comfortable height. Below the beams may be one or more pneumatic cylinders (not shown), which move in unison a clamping mechanism (not shown) that secures a mandrel/bladder assembly 2566 in place during the pressure cycle.

Using a lengthwise clamp (not shown), the mandrel/bladder assembly 2566 may be clamped along its entire length, eliminating the need for a large structure to withstand the loads the mandrel/bladder assembly 2566 will exert while under pressure.

A series of electric infrared heaters 2582 may be assembled and supported on a moveable unit (not shown) that is itself supported on a track (not shown), thus allowing the heaters to be positioned in place directly over the mold during the heating cycle, and then subsequently retracted out the way of the mandrel/bladder assembly 2566 during the pressure, loading, and unloading cycles.

The mandrel/bladder assembly 2566 may be constructed of an aluminum frame of sufficient strength to handle the molding pressure while being held by the clamps. Below the aluminum frame may be a hollow aluminum rectangular extrusion member (e.g., one off the shelf) which functions as the mandrel 2570, initiating the forming of the preform by pressing it into the mold cavity 2558 and folding the primary and supplemental composite material components upward.

The extrusion member or mandrel 2570 may be encased in a resilient, airtight membrane or bladder 2574. The resilient membrane or bladder 2574 may comprise a tube shape to match the aluminum extrusion member or mandrel 2570. In one aspect, as discussed above, the bladder 2574 is supported about only the bottom and side surfaces of the mandrel 2570, with the top of the mandrel 2570 being left exposed. In this respect, the top surface of the mandrel 2570 may come in contact and interface with a mold top 2578 used to enclose the cavity 2558 of the mold 2554. The mandrel 2570 serves as an air distribution manifold for delivering high pressure air into the resilient membrane or bladder 2574 quickly and evenly along its length one or more through holes drilled at regular intervals.

The mandrel/bladder assembly 2566 facilitates the process of forming the composite support member 2510, and particularly the preform of the primary composite support material composition 2526 and the various supplemental compositions 2530-a, 2530-b, and 2530-c, within the mold cavity 2558. It is noted that the primary and supplemental compositions may be consolidated together under pressure and heat to form a single unitary preform ready to be inserted into the mold 2554. The mandrel/bladder assembly 2566 facilitates initiation of the forming process and induces the needed molding pressure. The mandrel/bladder assembly 2566, retractable heaters 2582, and lengthwise clamp are all operable together to provide the advantages of the present invention.

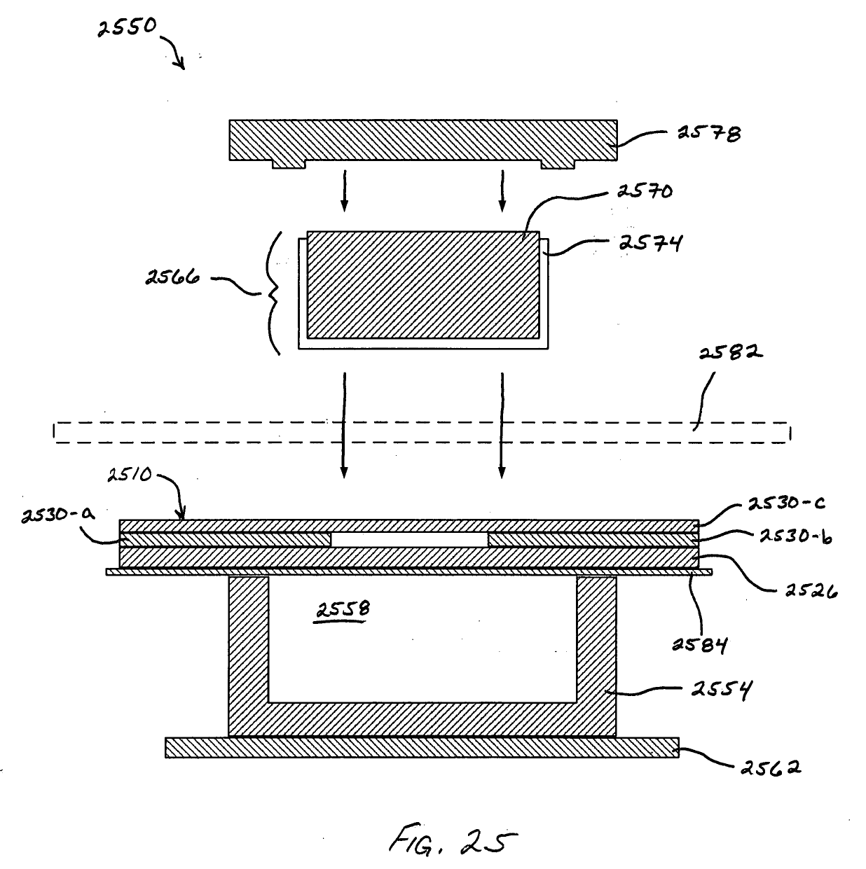

With reference to FIG. 26, illustrated is a detailed cross-section of a composite material composition 2628 comprising material fibers 2644 oriented on a zero degree angle with respect to a longitudinal axis, and material fibers 2648 oriented transverse to the longitudinal axis, particularly on a ninety degree angle, and how these are secured to one another via a resin matrix 2652. FIG. 26 may represent a single composite material composition (either a primary or supplemental one) having such material fibers, or it may represent layers of material fibers from different composite material compositions. Once the fibers are properly positioned and a resin matrix introduced, the fibers may be compressed and the resin cured to form a preform ready for insertion into a mold.

With respect to the material fibers, the performance properties of the composite support member are largely determined by the orientation and number of composite material fibers making up the support member. Along the longitudinal length of the support member, the total fiber content will typically comprise more fibers oriented on a zero degree angle with respect to a longitudinal axis of the support member. However, there may also be present material fibers oriented transverse to this longitudinal axis, namely material fibers oriented on an angle between 45 and 90 degrees, and preferably between 60 and 90 degrees, with fibers oriented on ninety degree angles being specifically preferred as these will provide the greatest enhancement and efficiency of strength, stiffness and other desirable properties. Material fibers oriented on angles less than 90°, but yet greater than 0°, will still provide somewhat of an increase or enhancement of strength and stiffness and other properties, but this will most likely be less than that achieved by using material fibers oriented on 90° angles.

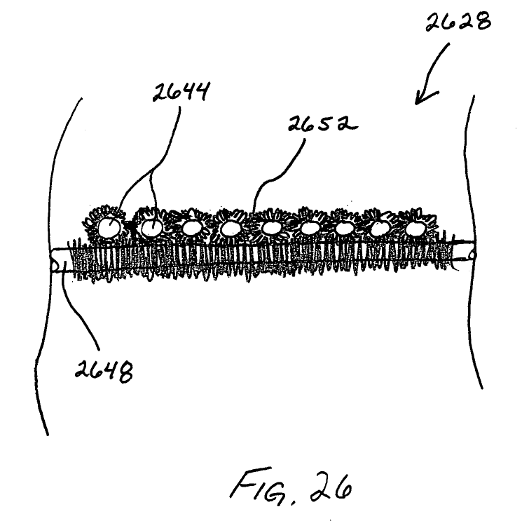

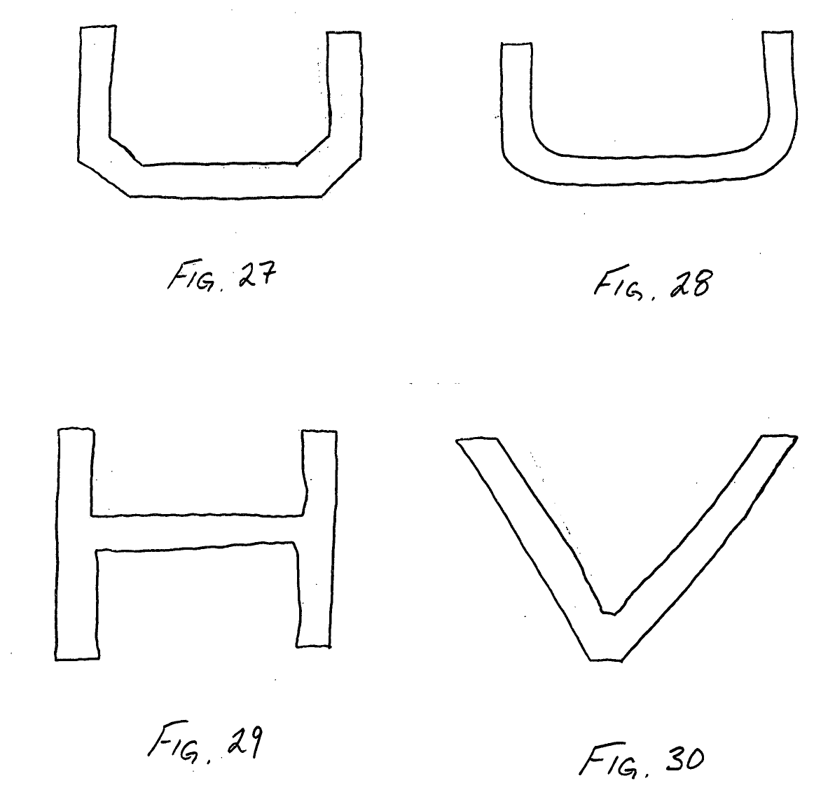

Although the present invention contemplates a single composite support member comprising all longitudinally oriented material fibers (such as the ladder rail described in FIGS. 2-20), the present invention also contemplates providing material fibers oriented in different directions within a single composite support member (such some embodiments of the ladder rails described in FIGS. 21-30). In order to optimize the strength to weight ratio and still provide high performance properties, it has been discovered that it is advantageous to provide a single composite support member having both longitudinally and transversely oriented material fibers, each with respect to a longitudinal axis of the support member. Specifically, it has been discovered that the transversely oriented material fibers are capable of securing the longitudinally oriented fibers to enhance the efficiency of the performance properties of the support member, such as strength, stiffness and torsional resistance. For example, a series of transversely oriented material fibers may be used to secure together opposing sides of the support member and the longitudinally oriented fibers therein. Another advantage is that matting used in prior related support members to increase strength and stiffness may be eliminated.

For a support member having optimized performance properties, it has been discovered that the total material fiber content of the support member will preferably comprise between 5 and 30 percent transversely oriented material fibers, and between 70 and 95 percent longitudinally oriented material fibers. In other words, support members for use in climbing structures may be optimized by providing at least some material fibers that are oriented transversely to the several longitudinally oriented material fibers. However, there will generally be more longitudinally oriented material fibers than transversely oriented material fibers.

Climbing structures may be subject to various industry standards, such as commonly known ANSI standards. ANSI provides tests for climbing structures in order to rate their performance and to see if they can perform within the set standards. In the example of a ladder, ANSI states that in order to achieve an acceptable rating, the ladder can only deflect a certain amount or distance under a given load. In addition, the ladder must meet a strength test, which is a failure test, wherein the ladder is required to hold a given load until failure. There are also various incline tests, torque tests, foot braking tests, and others. The results of these tests are directly affected by the number, relationship and orientation of respective material fibers present within the ladder rails making up the ladder.

With reference to FIGS. 27-30, illustrated are several cross-sections of composite support members, each comprising opposing flanges that extend upwards to define a channel. The specific channel-type configurations shown are not meant to be limiting in any way, Indeed, other configurations are contemplated and possible, as will be recognized by those skilled in the art.

Again, the above description pertaining to molded composite support members in the form of molded composite ladder rails is not intended to be limiting in any way, as the techniques and concepts described above and set forth in the drawings is intended to be applicable to the manufacture of other types of molded composite support members for use in other types of climbing structures.

The foregoing detailed description describes the invention with reference to specific exemplary embodiments. However, it will be appreciated that various modifications and changes can be made without departing from the scope of the present invention as set forth in the appended claims.

The detailed description and accompanying drawings are to be regarded as merely illustrative, rather than as restrictive, and all such modifications or changes, if any, are intended to fall within the scope of the present invention as described and set forth herein. More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A climbing structure configured to support a load, said climbing structure comprising:
a surface operable to receive a load thereon; and
at least one composite support member configured to support said surface, and having variable performance properties along a longitudinal length thereof, said composite support member comprising:
a primary composite material composition having an elongate, channel-shaped configuration; and
a supplemental composite material composition operable to adapt selective regions of said primary composite material composition to provide selective localized reinforcement for facilitating and enhancing said variable performance properties.

2. The climbing structure of claim 1, wherein said supplemental composite material composition is operable to adapt selective regions of said primary composite material composition in a longitudinal direction.

3. The climbing structure of claim 1, wherein said composite support member comprises opposing flanges extending upward to define a channel of said channel-shaped configuration.

4. The climbing structure of claim 1, further comprising first and second composite support members interconnected to one another to support said surface and said load.

5. The climbing structure of claim 1, wherein said composite support member is used to construct a climbing structure of the type selected from the group consisting of a ladder, scaffolding, a platform, a display, a plank, and bleachers.

6. A composite support member operable within a climbing structure, said composite support member comprising:
a primary composite material composition having an elongate, channel-shaped configuration, and comprising material fibers oriented on a zero degree angle with respect to a longitudinal axis of said support member; and
a supplemental composite material composition operable to selectively reinforce said primary composite material composition and to facilitate variable performance properties of said support member along a longitudinal length thereof, said supplemental composite material composition comprising a plurality of composite material fibers oriented to enhance said performance properties.

7. The composite support member of claim 6, wherein said primary composite material composition comprises material fibers oriented transverse to said longitudinal axis to increase the performance properties of said primary composite material composition.

8. The composite support member of claim 6, wherein said support member comprises opposing flanges extending upward to define a channel of said channel-shaped configuration.

9. The composite support member of claim 8, wherein said supplemental composite composition is positioned and extends about a surface of said opposing flanges and partially about said web, through an intersection of said flanges and said web, thus reinforcing said intersection.

10. The composite support member of claim 6, wherein said supplemental composite material operates to only reinforce said opposing flanges, thus eliminating a need for reinforcing any web or back portions of said primary composite material composition.

11. The composite support member of claim 6, wherein said material fibers of said supplemental composite material composition are all oriented on a zero degree angle with respect to said longitudinal axis, and are used to reinforce the material fibers of the primary composite material composition, also oriented on a zero degree angle with respect to said longitudinal axis.

12. The composite support member of claim 6, wherein at least a portion of said material fibers of said supplemental composite material composition are oriented on a zero degree angle with respect to said longitudinal axis, and wherein at least a portion of said material fibers of said supplemental composite material composition are oriented transverse to said longitudinal axis in order to optimize and/or enhance a strength to weight ratio, and to increase stiffness of said support member.

13. The composite support member of claim 12, wherein between 5 and 30 percent of said material fibers present within said supplemental composite material composition are oriented transverse to said longitudinal axis, and wherein between 70 and 95 percent of said material fibers present within said supplemental composite material composition are oriented on a zero degree angle with respect to said longitudinal axis, said percentages being based on a total material fiber content.

14. The composite support member of claim 12, wherein said material fibers of said supplemental composite material composition oriented transverse to said longitudinal axis are oriented on an angle between 45 and 90 degrees with respect to said longitudinal axis.

15. The composite support member of claim 12, wherein at least a portion of said material fibers of said primary composite material composition oriented on a zero degree angle with respect to said longitudinal axis are operably secured together by at least a portion of said material fibers of said supplemental composite material composition oriented transverse to said longitudinal axis.

16. The composite support member of claim 12, wherein at least a portion of said material fibers of said primary composite material composition oriented on a zero degree angle with respect to said longitudinal axis are operably secured together by at least a portion of material fibers, also within said primary composite material composition, oriented transverse to said longitudinal axis.

17. The composite support member of claim 6, wherein said supplemental composite material composition resides in and forms a sleeve configured to be selectively and removably coupled to said primary composite material composition to provide localized reinforcement to said primary composite material composition and said support member, said sleeve not being integrally formed with and comprising a material composition independent of said primary composite material composition.

18. The composite support member of claim 6, wherein said supplemental composite material composition is consolidated with said primary composite material composition to comprise an integrally formed unitary composite material composition.

19. The composite support member of claim 18, wherein said primary and supplemental composite material compositions are of a thermoplastic type, and wherein said supplemental composite material composition is remolded together with said primary composite material composition to effectuate integral consolidation of said primary and secondary composite material compositions.

20. The composite support member of claim 6, wherein said supplemental composite material composition spans substantially an entire length of said support member to maintain a uniform cross-sectional area as taken laterally across said longitudinal axis of said support member.

21. The composite support member of clam 6, wherein said supplemental composite material composition is located in select regions of said support member to be reinforced, thus providing a non-uniform cross-sectional area as taken laterally across said longitudinal axis of said support member.

22. The composite support member of claim 6, wherein said supplemental composite material composition tapers along its length to more evenly distribute loads across said primary composite material composition, and to reduce the concentration and localization of forces within a given area.

23. The composite support member of claim 6, wherein said primary and supplemental composite material compositions comprise a thermoplastic makeup.

24. A composite support member for use within a climbing structure, said composite support member comprising:
a primary composite material composition having an elongate, channel-shaped configuration; and
a supplemental composite material composition operable to adapt said primary composite material composition along substantially an entire length thereof, to provide reinforcement for facilitating and enhancing one or more performance properties of said primary composite material composition,
said primary composite material composition and said supplemental composite material composition configured to provide a uniform cross-sectional area along a longitudinal length of said support member.

25. The composite support member of claim 24, wherein said support member comprises opposing first and second flanges extending upward from a web, said flange portions having a reinforced increased thickness with respect to a thickness of a majority of said web.

26. The composite support member of claim 25, wherein said supplemental composite composition extends about said first and second flanges and partially about said web, through an intersection of said first and second flanges and said web, thus reinforcing said intersection.

27. A method for fabricating a composite support member operable within a climbing structure, said method comprising:
preparing a primary composite material composition having an elongate, channel-shaped configuration;
preparing a supplemental composite material composition; and
adapting a region of said primary composite material composition with said supplemental composite material composition to provide selective localized reinforcement of said primary composite material composition, and to form said composite support member, said supplemental composite material facilitating variable performance properties along a longitudinal length of said support member.

28. The method of claim 27, wherein said preparing a supplemental composite material composition comprises preparing a sleeve configured to be selectively and removably coupled to said primary composite material composition to provide said localized reinforcement of said primary composite material composition, said sleeve being and comprising a material composition independent of said primary composite material composition.

29. The method of claim 27, wherein said adapting comprises consolidating said supplemental composite material composition with said primary composite material composition to comprise an integrally formed unitary composite material composition.

30. The method of claim 29, wherein said supplemental composite material composition is remolded together with said primary composite material composition to achieve said consolidating of said supplemental composite material composition with said primary composite material composition.

31. The method of claim 27, wherein said preparing said primary composite material composition comprises orienting one or more material fibers of said primary composite material composition on a zero degree angle with respect to a longitudinal axis thereof, and wherein said preparing said supplemental composite material composition comprises orienting one or more material fibers of said supplemental composite material composition on a zero degree angle with respect to said longitudinal axis.

32. The method of claim 31, wherein said preparing said supplemental composite material composition comprises orienting a majority of material fibers of said supplemental composite material composition on a zero degree angle with respect to said longitudinal axis, and orienting a portion of said material fibers transverse to said longitudinal axis.

33. The method of claim 32, wherein said adapting further comprises operably securing together at least a portion of said material fibers of said primary composite material composition oriented on a zero degree angle with respect to said longitudinal axis with at least a portion of said material fibers of said supplemental composite material composition oriented transverse to said longitudinal axis.

34. The method of claim 27, further comprising optimizing said performance properties of said support member by strategically relating within said supplemental composite material composition a number and orientation of transverse material fibers to a number of material fibers oriented on a zero degree angle, each with respect to a longitudinal axis, and adapting these to reinforce a region of said primary composite material composition.

35. A method for providing a climbing structure, said method comprising:
obtaining first and second composite support members, each having variable performance properties along a longitudinal length thereof provided by adapting a region of a primary composite material composition with a supplemental composite material composition to provide selective localized reinforcement of said primary composite material composition; and
interconnecting said first and second composite support members to form at least a portion of said climbing structure.
